(19) United States
(12) Patent Application Publication
(10) Pub. No.: US 2026/0109521 A1
(43) Pub. Date: Apr. 23, 2026

(54) COMPOSTABLE CELLULOSIC-BASED COMPOSITE PACKAGING STRUCTURES

(71) Applicant: PROAMPAC HOLDINGS INC., Cincinnati, OH (US)

(72) Inventors: Terry J. Leis, Huntington, MA (US); Adam J. Edinger, Rochester, NY (US); Raymond J. Recchia, Cincinnati, OH (US); Scott E. Jacobson, Kaukauna, WI (US); James E. Tierney, South Hadley, MA (US); Seyed Hesamoddin Tabatabaei, Mason, OH (US); Amir Saffar, Laval (CA)

(21) Appl. No.: 19/414,962

(22) Filed: Dec. 10, 2025

Related U.S. Application Data
(63) Continuation-in-part of application No. 18/734,690, filed on Jun. 5, 2024.
(60) Provisional application No. 63/472,257, filed on Jun. 9, 2023.

(51) Int. Cl. B65D 65/40; B32B 27/10; B32B 27/36; B65D 65/46

(52) U.S. Cl. CPC B65D 65/40; B32B 27/10; B32B 27/36; B65D 65/466; B32B 2250/03; B32B 2250/40; B32B 2307/7163; B32B 2439/00

(57) ABSTRACT

A compostable laminated packaging film comprises a first cellulosic layer having a first major surface and a second major surface opposite the first major surface. The first major surface of the first cellulosic layer is configured to face away from a product to be packaged and the second major surface of the first cellulosic layer has undergone surface treatment. A second cellulosic layer has a first major surface and a second major surface opposite the first major surface. The first major surface of the second cellulosic layer is configured to face toward a product to be packaged and the second major surface of the second cellulosic layer has undergone surface treatment. A pattern bonded extrusion interlayer comprises a compostable polymer disposed between the first and second cellulosic layers and defines bonded and unbonded regions arranged in a patterned configuration.

### CROSS REFERENCE TO RELATED APPLICATIONS

This application is a continuation in part of U.S. nonprovisional application Ser. No. 18/734,690 filed Jun. 5, 2024, which in turn claims the priority benefit of U.S. provisional application no. 63/472,257 filed Jun. 9, 2023. Each of the aforementioned applications is incorporated herein by reference in its entirety.

### BACKGROUND

The present invention relates to a compostable, cellulosic-based packaging structure comprising one or more inner layers formed of a compostable or biodegradable polymer in between two outer layers, each outer layer formed of a cellulosic material.

Commonly, composite paper sheet materials used for food wrap or other packaging applications comprise laminations of paper with a barrier layer such as foil (e.g., aluminum foil) or polymer layer such as polyethylene. The barrier layer provides a barrier to moisture and gases while the paper layer(s) provide strength. A paper layer on the outside provides a printable surface for labeling. In the case of food packaging, the paper layer on the inside absorbs excess moisture or grease from the food product to prevent it from becoming soggy. In the case of a quilted structure, the quilting pattern helps to retain heat, keeping the food product warm for longer periods of time. However, because such paper/foil or paper/polyethylene structures are neither recyclable nor compostable, they can have a negative environmental impact since they can end up in landfills or the environment where they can persist for many years.

The present disclosure contemplates a new and improved compostable, cellulosic-based packaging structure and method which overcome the above-referenced problems and others.

### SUMMARY

Compostable laminated packaging films include a first cellulosic layer having a first major surface and a second major surface opposite the first major surface, the first major surface of the first cellulosic layer configured to face away from a product to be packaged and wherein the second major surface of the first cellulosic layer has undergone surface treatment. A second cellulosic layer has a first major surface and a second major surface opposite the first major surface, the first major surface of the second cellulosic layer configured to face toward a product to be packaged and wherein the second major surface of the second cellulosic layer has undergone surface treatment. In embodiments, one or more compostable polymer layers are disposed intermediate the first cellulosic layer and the second cellulosic layer. In embodiments, an extrusion coated compostable polymer layer and an adhesive layer are disposed intermediate the first cellulosic layer and the second cellulosic layer. In embodiments, an extrusion coated compostable polymer layer and a compostable polymer extrusion interlayer are disposed intermediate the first cellulosic layer and the second cellulosic layer. In further aspects, methods for the manufacture of compostable laminated packaging films are provided.

One advantage of the present development resides in the composability of the packaging structures herein.

Another advantage of the present development resides in the ability of the packaging structures herein to survive high temperature conditions.

Yet another advantage of the packaging structures herein is found in their ability to resist grease or oil permeation.

Still another advantage of the packaging structures herein resides in their insulative or heat retention properties. In the case of a food wrap for warm or hot food, the present packaging structures help to retain the heat within the wrap to keep the food warm for a longer period.

Still another advantage of the packaging structures herein is the ability to utilize materials that have regulatory approval such as FDA approval for use in food-contact applications.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is a cross sectional view of a compostable cellulosic-based packaging structure in accordance with a first embodiment.

FIG. 1B is a cross sectional view of a compostable cellulosic-based packaging structure in accordance with a second embodiment.

FIG. 1C is a cross sectional view of a compostable cellulosic-based packaging structure in accordance with a third embodiment.

FIG. 1D is a cross sectional view of a compostable cellulosic-based packaging structure in accordance with a fourth embodiment.

FIG. 2A is a cross sectional view of a compostable cellulosic-based packaging structure in accordance with a fifth embodiment.

FIG. 2B is a cross sectional view of a compostable cellulosic-based packaging structure in accordance with a sixth embodiment.

FIG. 2C is a cross sectional view of a compostable cellulosic-based packaging structure in accordance with a seventh embodiment.

FIG. 3A is a cross sectional view of a compostable cellulosic-based packaging structure in accordance with an eighth embodiment.

FIG. 3B is a cross sectional view of a compostable cellulosic-based packaging structure in accordance with a ninth embodiment.

FIG. 3C is a cross sectional view of a compostable cellulosic-based packaging structure in accordance with a tenth embodiment.

FIG. 3D is a cross sectional view of a compostable cellulosic-based packaging structure in accordance with an eleventh embodiment.

FIG. 4A illustrates an exemplary process line for forming the first ply of the compostable cellulosic-based packaging structures of FIGS. 1A and 1B.

FIG. 4B illustrates a first exemplary process line for laminating the first and second plies of the compostable cellulosic-based packaging structures of FIGS. 1A and 1B.

FIG. 4C illustrates a second exemplary process line for laminating the first and second plies of the compostable cellulosic-based packaging structure of FIGS. 1A and 1B.

FIG. 4D illustrates an exemplary process line for forming the second ply of the compostable cellulosic-based packaging structures of FIGS. 1C and 1D.

FIG. 4E illustrates a first exemplary process line for laminating the first and second plies of the compostable cellulosic-based packaging structures of FIGS. 1C and 1D.

FIG. 4F illustrates a second exemplary process line for laminating the first and second plies of the compostable cellulosic-based packaging structure of FIGS. 1C and 1D.

FIG. 5A illustrates an exemplary process line for forming the compostable cellulosic-based packaging structure of FIG. 2A.

FIGS. 5B and 5C illustrate exemplary process lines for forming the compostable cellulosic-based packaging structure of FIGS. 2B and 2C, respectively.

FIG. 6A illustrates an exemplary process line for forming the first ply of the compostable cellulosic-based packaging structures of FIGS. 3A and 3B.

FIG. 6B illustrates an exemplary process line for laminating the first and second plies of the compostable cellulosic-based packaging structure of FIG. 3A or 3B.

FIG. 6C illustrates an exemplary process line for forming the second ply of the compostable cellulosic-based packaging structure of FIGS. 3C and 3D.

FIG. 6D illustrates an exemplary process line for laminating the first and second plies of the compostable cellulosic-based packaging structure of FIG. 3C or 3D.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “a” or “an,” are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

As used herein, the terms “front,” “rear,” “upper,” “lower,” “upwardly,” “downwardly,” “left,” “right,” and other orientation descriptors are intended to facilitate the description of the exemplary embodiments of the present invention, and are not intended to limit the structure thereof to any particular position or orientation.

The terms “exterior” and “interior” are used herein to refer to a position in relation to a product to be packaged using the multilayer packaging structures herein, while the terms “outer” and “inner” are used herein to refer to a position in relation to other layers of the multilayer packaging structures herein.

As used herein, the term “exterior layer” refers to a layer of a multilayer packaging structure which is furthest from the product to be packaged in relation to the other layers of the multilayer structure. The term “exterior facing surface” of a layer of a multilayer packaging structure is the surface of such layer that faces away from the product being packaged within a multilayer packaging structure herein or a packaging article formed thereof. Likewise, the term “exterior surface” of a multilayer packaging structure is the surface of the structure that is intended to face away from a product being packaged within the structure.

As used herein, the term “interior layer” refers to a layer of a multilayer packaging structure which is closest to or is intended to contact the product to be packaged within a multilayer structure herein in relation to the other layers of the multilayer structure. The term “interior facing surface” of a layer of a multilayer packaging structure herein is the surface of such layer that faces toward the product being packaged within a multilayer packaging structure herein or a packaging article formed thereof. Likewise, the term “interior surface” of a multilayer packaging structure herein is the surface of the structure that faces toward or is intended to face toward or contact a product being packaged within the structure.

As used herein, the term “inner layer” refers to a layer within a multilayer packaging structure herein is that is not exposed to handling and the environment. Inner layers may provide functionality as needed for particular applications. For example, inner layers may provide barrier protection and/or structural strength. As an example, an exemplary inner layer provides protection to packaged food or other product for freshness and/or a barrier to moisture and/or oxygen, and/or a barrier to migration of moisture, oils, and the like from packaged food or other product from the interior surface of the multilayer packaging structure to the exterior surface of the multilayer packaging structure. As another example, an inner layer may also be a structural layer which provides one properties including but not limited to general durability, puncture strength, resistance to curling, tear or flex crack resistance, and the like.

As used herein, the term “outer layer” refers to a layer which comes in immediate contact with the outside environment or atmosphere. Therefore, the multilayer packaging structures herein have two outer layers, namely, the interior layer and the exterior layer.

As used herein, the term “compostable” means that a material is capable of breaking down into non-toxic components in the presence of oxygen, moisture, and microorganisms which facilitate the breakdown of organic matter. In embodiments, the term “compostability” is intended to refer to any one of more of marine compostability (the ability of a material to decompose in a marine or aquatic environment), industrial compostability (the ability of a material to degrade within an industrial composting facility) and home compostability (the ability of a material to decompose in a backyard or home composting system).

As used herein, the terms “grease resistant” or “grease resistance” refer to the character of the barrier layer in blocking or impeding the absorption or transmission of grease or oil in any significant quantity.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the term “surface treatment” means a surface modification treatment to increase the surface energy of a material, which can improve adhesion between two surfaces.

As used herein, the term “packaging structure” means a web of sheet material having a structure as disclosed herein, as well as a packaging article manufactured therefrom, including sheets or wraps, bags, pouches, and the like.

All compositional percentages used herein are presented on a “by weight” basis, unless specifically stated otherwise.

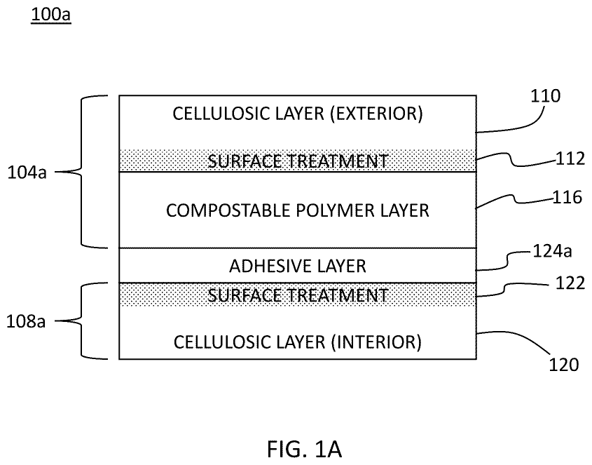

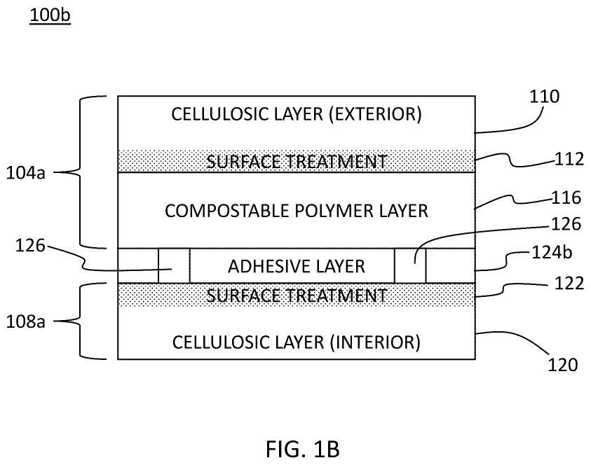

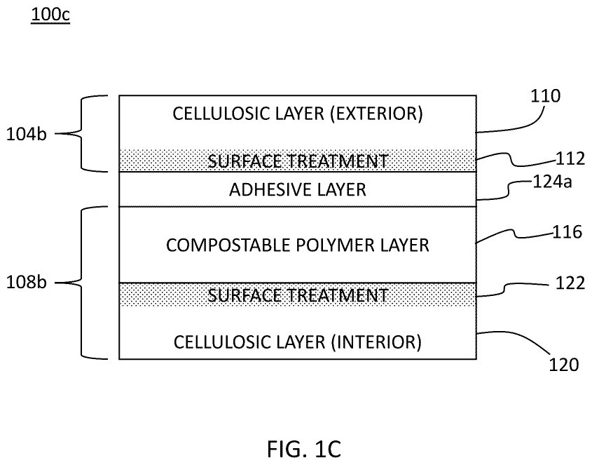

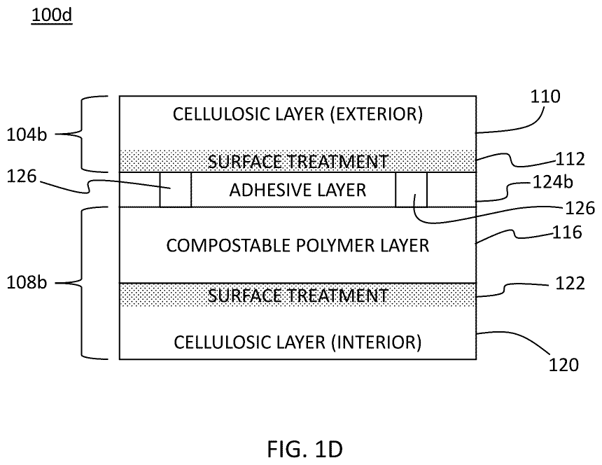

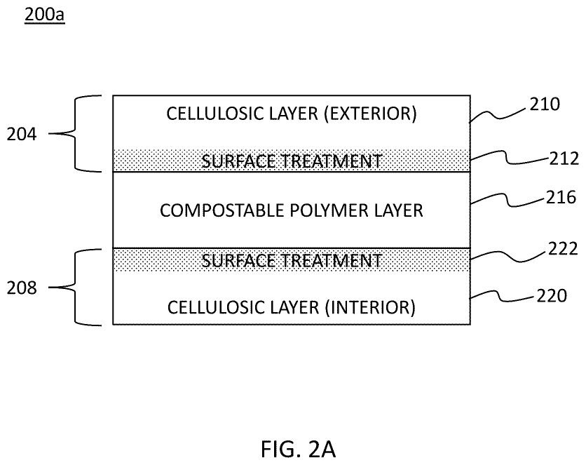

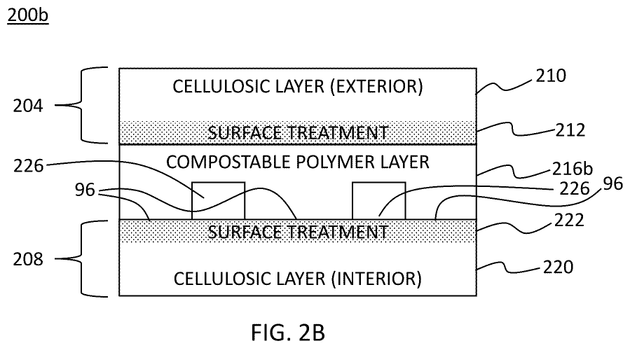

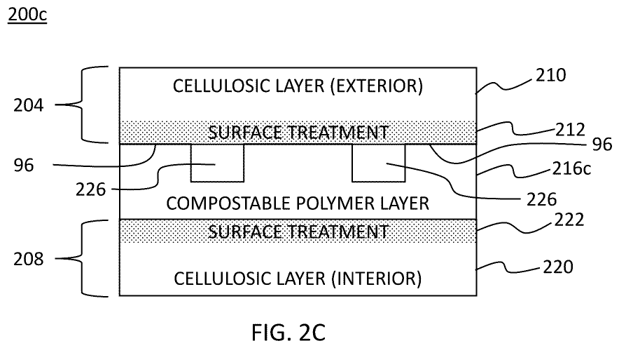

Referring now to the drawings, like reference numerals are used to describe like or analogous items in which the hundreds digit has been increased to correspond to the figure number (e.g., cellulosic layer 110 in FIG. 1 corresponds to cellulosic layer 210 in FIG. 2A, and so forth). The description in reference to any given reference numeral herein is equally applicable to other reference numerals that differ only in the hundreds digit, unless specifically stated otherwise.

Referring now to FIG. 1A, a packaging structure 100a comprises a first ply 104a and a second ply 108a. The first ply 104a includes a first cellulosic layer 110, which has a first major surface, which is an exterior facing surface, and a second major surface, which is an interior facing surface, the second major surface opposite the first major surface. The first ply 104a further includes a compostable polymer layer 116 disposed on the second major surface of the first cellulosic layer 110. The compostable polymer layer 116 forms an inner layer of the structure 100a. The second ply 108a comprises a second cellulosic layer 120, which has a first major surface, which is an interior facing surface, and a second major surface, which is an exterior facing surface the second major surface opposite the first major surface.

The first ply 104a and the second ply 108a are adhesively laminated to each other via an adhesive layer 124a. In the illustrated embodiment of FIG. 1A, the adhesive 124a is applied as continuous or complete coverage layer. In embodiments, the adhesive is a compostable adhesive in which case there is no restriction on the quantity of adhesive in the structure 100a. In embodiments, the adhesive is a non-compostable adhesive, wherein the adhesive after drying comprises 1% or less by weight of the total weight of the structure 100a.

The second major surface of the first cellulosic layer 110 is a surface which has undergone a surface treatment 112 to promote bonding between the first cellulosic layer 110 and the compostable polymer layer 116. The second major surface of the second cellulosic layer 120 is a surface which has undergone a surface treatment 122 to promote bonding between the second cellulosic layer 120 and the adhesive layer 124a. In embodiments, the treated surfaces 112 and 122, which may be the same or different treatments, are formed via flame treatment, corona treatment, plasma treatment, ozone treatment, or primer treatment. In preferred embodiments, the treated surfaces 112 and 122 are flame treated surfaces. In the case of primer treatment 112 and/or 122, the primer may comprise a compostable or non-compostable composition. When the primer is a compostable primer, there is no restriction on the quantity of adhesive. When the primer is a non-compostable primer, the primer should comprise 1% or less by weight after drying of the total weight of the structure 100a.

In embodiments, the first and second cellulosic layers 110 and 120, which may be the same or different, are formed of a paper material or a cellophane material. In embodiments, when the first and second cellulosic layers 110 and/or 120 are paper, the paper has a basis weight in the range of 20 #/ream to 100 #/ream, e.g., 20 #/ream, 30 #/ream, 40 #/ream, 50 #/ream, 60 #/ream, 70 #/ream, 80 #/ream, 90 #/ream, or 100 #/ream. All ream weights/basis weights herein are based on a 3000 ft² ream unless specified otherwise. In embodiments, when the first and second cellulosic layers 110 and/or 120 are cellophane, the layers have a thickness in the range of 8 microns to 75 microns. In embodiments, the first cellulosic layer 110 is configured to impart dead fold or crease retention properties to the structure 100a.

In embodiments, the first major surface of the first cellulosic layer 110 is configured to define an exterior facing surface of the structure 100a, i.e., the non-product-contacting side. In embodiments, the first major surface of the cellulosic layer 110 includes a printed ink/indicia layer (not shown), e.g., applied with a printing apparatus.

The compostable polymer layer 116 is a compostable or biodegradable polymer, such as a polyhydroxyalkanoate (PHA), polybutylene succinate (PBS), polybutyrate adipate terephthalate (PBAT), or polylactic acid (PLA), or a blend or mixture of compostable or biodegradable polymers such as polyhydroxyalkanoate (PHA), polybutylene succinate (PBS), polybutyrate adipate terephthalate (PBAT), polylactic acid (PLA), or polycaprolactone (PCL). In embodiments, the compostable polymer layer 116 comprises 90-100% by weight of one or more compostable or biodegradable polymers and 0-10% non-compostable materials. As described below, the compostable polymer layer 116 is brought onto the second major surface of the first cellulosic layer 110 via extrusion coating. In embodiments, the compostable polymer layer 116 is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layer 116 provides grease resistance, moisture barrier, and heat retention properties to the structure 100a.

In embodiments, the first major surface of the second cellulosic layer 120 is configured to be the interior surface of the structure 100a, i.e., the product-contacting surface. In embodiments, the second cellulosic layer 120 is configured to impart dead fold or crease retention properties to the structure 100a. In embodiments, the second cellulosic layer 120 is configured to absorb excess moisture or grease from the product.

In the embodiment of FIG. 1A, the adhesive layer 124a is applied as a continuous coating. In embodiments, the adhesive layer 124a is formed of a biodegradable or compostable adhesive. In embodiments, the adhesive layer 124a is formed of a conventional non-biodegradable or non-compostable adhesive. In embodiments, when the adhesive layer 124a is a non-compostable or non-biodegradable adhesive, the amount of adhesive after drying is present after drying in the range of 0.1-10% by weight of the final structure 100a, and more preferably 0.1 to 1% by weight of the final structure 100a.

Referring now to FIG. 1B, a packaging structure 100b comprises a first ply 104a and a second ply 108a. The first ply 104a includes a first cellulosic layer 110, which has a first major surface, which is exterior facing, and a second major surface, which is interior facing and opposite the first major surface. The first ply 104a further includes a compostable polymer layer 116 disposed on the second major surface of the first cellulosic layer 110. The second ply 108a comprises a second cellulosic layer 120, which has a first major surface, which is interior facing, and a second major surface, which is exterior facing and opposite the first major surface.

The first ply 104a and the second ply 108a are adhesively laminated to each other via an adhesive layer 124b. In the illustrated embodiment of FIG. 1B, the adhesive layer 124b is applied discontinuously such that air pockets 126 are defined between the second cellulosic layer 120 and the compostable polymer layer 116. In embodiments, the adhesive layer 124b is applied in a specific pattern or design. In embodiments, the adhesive layer 124b is an adhesive layer having a dot pattern, grid pattern, striped pattern, chevron pattern, random pattern, or the like.

The second major surface of the first cellulosic layer 110 is a surface which has undergone a surface treatment 112 to promote bonding between the first cellulosic layer 110 and the compostable polymer layer 116. The second major surface of the second cellulosic layer 120 is a surface which has undergone a surface treatment 122 to promote bonding between the second cellulosic layer 120 and the adhesive layer 124b. In embodiments, the treated surfaces 112 and 122, which may be the same or different treatments, are formed via flame treatment, corona treatment, plasma treatment, or ozone treatment. In preferred embodiments, the treated surfaces 112 and 122 are flame treated surfaces. In the case of primer treatment 112 and/or 122, the primer may comprise a compostable or non-compostable composition. When the primer is a compostable primer, there is no restriction on the quantity of adhesive. When the primer is a non-compostable primer, the primer should comprise 1% or less by weight after drying of the total weight of the structure 100b.

In embodiments, the first and second cellulosic layers 110 and 120, which may be the same or different, are formed of a paper material or a cellophane material. In embodiments, when the first and second cellulosic layers 110 and/or 120 are paper, the paper has a basis weight in the range of 20 #/ream to 100 #/ream, e.g., 20 #/ream, 30 #/ream, 40 #/ream, 50 #/ream, 60 #/ream, 70 #/ream, 80 #/ream, 90 #/ream, or 100 #/ream. All ream weights/basis weights herein are based on a 3000 ft² ream unless specified otherwise. In embodiments, when the first and second cellulosic layers 110 and/or 120 are cellophane, the layers have a thickness in the range of 8 microns to 75 microns. In embodiments, the first cellulosic layer 110 is configured to impart dead fold or crease retention properties to the structure 100b.

In embodiments, the first major surface of the first cellulosic layer 110 is configured to define an exterior facing surface of the structure 100b, i.e., the non-product-contacting side. In embodiments, the first major surface of the cellulosic layer 110 includes a printed ink/indicia layer (not shown), e.g., applied with a printing apparatus.

The compostable polymer layer 116 is a compostable or biodegradable polymer as described above. In embodiments, the compostable polymer layer 116 comprises 90-100% by weight of one or more compostable or biodegradable polymers and 0-10% non-compostable materials. As described below, the compostable polymer layer 116 is brought onto the second major surface of the first cellulosic layer 110 via extrusion coating. In embodiments, the compostable polymer layer 116 is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layer 116 provides grease resistance, moisture barrier, and heat retention properties to the structure 100b.

In embodiments, the second cellulosic layer 120 is configured to be the interior surface of the structure 100b, i.e., the product-contacting side. In embodiments, the second cellulosic layer 120 is configured to impart dead fold or crease retention properties to the structure 100b. In embodiments, the second cellulosic layer 120 is configured to absorb excess moisture or grease from the product.

The adhesive layer 124b is applied discontinuously such that air pockets 126 are formed between the first ply 104a and the second ply 108a that impart insulative or heat retention properties to the structure 100b. The use of a patterned or otherwise discontinuous adhesive layer 124b also reduces the amount of adhesive in the structure 100b. In embodiments, the adhesive layer 124b is formed of a biodegradable or compostable adhesive. In embodiments, the adhesive layer 124b is formed of a conventional a non-biodegradable or non-compostable adhesive. In embodiments, when the adhesive layer 124b is a non-compostable or non-biodegradable adhesive, the amount of adhesive is present after drying in the range of 0.1-10% by weight of the final structure 100b, and more preferably 0.1 to 1% by weight of the final structure 100b. In the case of a non-compostable adhesive layer 124b, use of a patterned or otherwise discontinuous adhesive layer 124b reduces the quantity of noncompostable material in the structure 100b.

Referring now to FIG. 1C, a packaging structure 100c comprises a first ply 104b and a second ply 108b. The first ply 104b includes a first cellulosic layer 110, which has a first major surface, which is an exterior facing surface, and a second major surface, which is an interior facing surface, the second major surface opposite the first major surface. The second ply 108b comprises a second cellulosic layer 120, which has a first major surface, which is an interior facing surface, and a second major surface, which is an exterior facing surface and which is opposite the first major surface. The second ply 108b further includes a compostable polymer layer 116 disposed on the second major surface of the second cellulosic layer 120. The compostable polymer layer 116 forms an inner layer of the structure 100c and may be formed of a material as described above.

The first ply 104b and the second ply 108b are adhesively laminated to each other via an adhesive layer 124a. In the illustrated embodiment of FIG. 1C, the adhesive 124a is applied as continuous or complete coverage layer. In embodiments, the adhesive is a compostable adhesive in which case there is no restriction on the quantity of adhesive in the structure 100c. In embodiments, the adhesive is a non-compostable adhesive, wherein the adhesive after drying comprises 1% or less by weight of the total weight of the structure 100c.

The second major surface of the first cellulosic layer 110 is a surface which has undergone a surface treatment 112 to promote bonding between the first cellulosic layer 110 and the adhesive layer 124a. The second major surface of the second cellulosic layer 120 is a surface which has undergone a surface treatment 122 to promote bonding between the second cellulosic layer 120 and the compostable polymer layer 116. In embodiments, the treated surfaces 112 and 122, which may be the same or different treatments, are formed via flame treatment, corona treatment, plasma treatment, or ozone treatment. In preferred embodiments, the treated surfaces 112 and 122 are flame treated surfaces. In the case of primer treatment 112 and/or 122, the primer may comprise a compostable or non-compostable composition. When the primer is a compostable primer, there is no restriction on the quantity of adhesive. When the primer is a non-compostable primer, the primer should comprise 1% or less by weight after drying of the total weight of the structure 100c.

In embodiments, the first and second cellulosic layers 110 and 120, which may be the same or different, are formed of a paper material or a cellophane material as described above.

In embodiments, the first major surface of the first cellulosic layer 110 is configured to define an exterior facing surface of the structure 100c, i.e., the non-product-contacting side. In embodiments, the first major surface of the cellulosic layer 110 includes a printed ink/indicia layer (not shown), e.g., applied with a printing apparatus. In embodiments, the first cellulosic layer 110 is configured to impart dead fold or crease retention properties to the structure 100c.

As described below, the compostable polymer layer 116 is brought onto the second major surface of the second cellulosic layer 120 via extrusion coating. In embodiments, the compostable polymer layer 116 is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layer 116 provides grease resistance, moisture barrier, and heat retention properties to the structure 100c.

In embodiments, the first major surface of the second cellulosic layer 120 is configured to be the interior surface of the structure 100c, i.e., the product-contacting surface. In embodiments, the second cellulosic layer 120 is configured to impart dead fold or crease retention properties to the structure 100c. In embodiments, the second cellulosic layer 120 is configured to absorb excess moisture or grease from the product.

In the embodiment of FIG. 1C, the adhesive layer 124a is applied as a continuous coating. In embodiments, the adhesive layer 124a is formed of a biodegradable or compostable adhesive. In embodiments, the adhesive layer 124a is formed of a conventional a non-biodegradable or non-compostable adhesive. In embodiments, when the adhesive layer 124a is a non-compostable or non-biodegradable adhesive, the amount of adhesive is present after drying in the range of 0.1-10% by weight of the final structure 100c, and more preferably 0.1 to 1% by weight of the final structure 100c.

Referring now to FIG. 1D, a packaging structure 100d comprises a first ply 104b and a second ply 108b. The first ply 104b includes a first cellulosic layer 110, which has a first major surface, which is exterior facing, and a second major surface, which is interior facing and opposite the first major surface. The second ply 108b comprises a second cellulosic layer 120, which has a first major surface, which is interior facing, and a second major surface, which is exterior facing and opposite the first major surface. The second ply 108b further includes a compostable polymer layer 116 disposed on the second major surface of the second cellulosic layer 120. The compostable polymer layer 116 forms an inner layer of the structure 100d and may be formed of a material as described above.

The first ply 104b and the second ply 108b are adhesively laminated to each other via an adhesive layer 124b. In the illustrated embodiment of FIG. 1D, the adhesive layer 124b is applied discontinuously such that air pockets 126 are defined between the first cellulosic layer 110 and the compostable polymer layer 116. In embodiments, the adhesive layer 124b is applied in a specific pattern or design. In embodiments, the adhesive layer 124b is an adhesive layer having a dot pattern, grid pattern, striped pattern, chevron pattern, random pattern, or the like. In embodiments, the adhesive layer 124b is formed of a conventional a non-biodegradable or non-compostable adhesive. In embodiments, when the adhesive layer 124b is a non-compostable or non-biodegradable adhesive, the amount of adhesive is present after drying in the range of 0.1-10% by weight of the final structure 100d, and more preferably 0.1 to 1% by weight of the final structure 100d. In the case of a non-compostable adhesive layer 124b, use of a patterned or otherwise discontinuous adhesive layer 124b reduces the quantity of noncompostable material in the structure 100d.

The second major surface of the first cellulosic layer 110 is a surface which has undergone a surface treatment 112 to promote bonding between the first cellulosic layer 110 and the adhesive layer 124b. The second major surface of the second cellulosic layer 120 is a surface which has undergone a surface treatment 122 to promote bonding between the second cellulosic layer 120 and the compostable polymer layer 116. In embodiments, the treated surfaces 112 and 122, which may be the same or different treatments, are formed via flame treatment, corona treatment, plasma treatment, or ozone treatment. In preferred embodiments, the treated surfaces 112 and 122 are flame treated surfaces.

In embodiments, the first and second cellulosic layers 110 and 120, which may be the same or different, are formed of a paper material or a cellophane material as described above.

In embodiments, the first major surface of the first cellulosic layer 110 is configured to define an exterior facing surface of the structure 100d, i.e., the non-product-contacting side. In embodiments, the first major surface of the cellulosic layer 110 includes a printed ink/indicia layer (not shown), e.g., applied with a printing apparatus. In embodiments, the first cellulosic layer 110 is configured to impart dead fold or crease retention properties to the structure 100d.

As described below, the compostable polymer layer 116 is brought onto the second major surface of the second cellulosic layer 120 via extrusion coating. In embodiments, the compostable polymer layer 116 is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layer 116 provides grease resistance, moisture barrier, and heat retention properties to the structure 100d.

In embodiments, the second cellulosic layer 120 is configured to be the interior surface of the structure 100d, i.e., the product-contacting side. In embodiments, the second cellulosic layer 120 is configured to impart dead fold or crease retention properties to the structure 100d. In embodiments, the second cellulosic layer 120 is configured to absorb excess moisture or grease from the product.

The adhesive layer 124b is applied discontinuously such that air pockets 126 are formed between the first ply 104b and the second ply 108b that impart insulative or heat retention properties to the structure 100d. The use of a patterned or otherwise discontinuous adhesive layer 124b also reduces the amount of adhesive in the structure 100d. In embodiments, the adhesive layer 124b is formed of a biodegradable or compostable adhesive. In embodiments, the adhesive layer 124b is formed of a conventional a non-biodegradable or non-compostable adhesive. In embodiments, when the adhesive layer 124b is a non-compostable or non-biodegradable adhesive, the amount of adhesive is present after drying in the range of 0.1-10% by weight of the final structure 100d, and more preferably 0.1 to 1% by weight of the final structure 100d. In the case of a non-compostable adhesive layer 124b, use of a patterned or otherwise discontinuous adhesive layer 124b reduces the quantity of noncompostable material in the structure 100d.

Referring now to FIG. 2A, a packaging structure 200a comprises a first ply 204 and a second ply 208. The first ply 204 includes a first cellulosic layer 210, which has a first major surface, which is exterior facing, and a second major surface, which is interior facing and opposite the first major surface. The second ply 208 comprises a second cellulosic layer 220, which has a first major surface, which is interior facing, and a second major surface, which is exterior facing and opposite the first major surface.

The first ply 204 and the second ply 208 are extrusion laminated to each other via an extruded compostable polymer layer 216. The compostable polymer layer 216 forms an inner layer of the structure 200a. The second major surface of the first cellulosic layer 210 is a surface which has undergone a surface treatment 212 to promote bonding between the first cellulosic layer 210 and the compostable polymer layer 216. The second major surface of the second cellulosic layer 220 is a surface which has undergone a surface treatment 222 to promote bonding between the second cellulosic layer 220 and the compostable polymer layer 216. In embodiments, the treated surfaces 212 and 222, which may be the same or different treatments, are formed via flame treatment, corona treatment, plasma treatment, or ozone treatment. In preferred embodiments, the treated surfaces 212 and 222 are flame treated surfaces.

In embodiments, the first and second cellulosic layers 210 and 220, which may be the same or different, are formed of a paper material or a cellophane material as described above by way of reference to the first and second cellulosic layers 110 and 120 appearing in FIG. 1.

In embodiments, the first major surface of the first cellulosic layer 210 is configured to define an exterior facing surface of the structure 200a, i.e., the non-product-contacting side. In embodiments, the first major surface of the cellulosic layer 210 includes a printed indicia layer. In embodiments, the first cellulosic layer 210 is configured to impart dead fold or crease retention properties to the structure 200a.

The compostable polymer layer 216 is formed of a material as described above by way of reference to the compostable polymer layer 116 appearing in FIG. 1. As described below, the compostable polymer layer 116 is applied as an extruded interlayer between the first cellulosic layers 210, 220 as a molten film. In embodiments, the compostable polymer layer 216 is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layer 216 provides grease resistance, moisture barrier, and heat retention properties to the structure 200a. In the illustrated embodiment, the compostable polymer layer 216 is applied as a continuous extrusion.

In embodiments, the second cellulosic layer 220 is configured to be the interior layer of the structure 200a, i.e., the product-contacting side. In embodiments, the second cellulosic layer 220 is configured to impart dead fold or crease retention properties to the structure 200a. In embodiments, the second cellulosic layer 220 is configured to absorb excess moisture or grease from the product.

Referring now to FIG. 2B, a packaging structure 200b comprises a first ply 204 and a second ply 208. The first ply 204 includes a first cellulosic layer 210, which has a first major surface, which is exterior facing, and a second major surface, which is interior facing and opposite the first major surface. The second ply 208 comprises a second cellulosic layer 220, which has a first major surface, which is interior facing, and a second major surface, which is exterior facing and opposite the first major surface.

The first ply 204 and the second ply 208 are extrusion laminated to each other via a compostable polymer based pattern bonded extrusion interlayer 216b. The compostable polymer based pattern bonded extrusion interlayer 216b forms an inner layer of the structure 200b. The second major surface of the first cellulosic layer 210 is a surface which has undergone a surface treatment 212 to promote bonding between the first cellulosic layer 210 and the compostable polymer based pattern bonded extrusion interlayer 216b. The second major surface of the second cellulosic layer 220 is a surface which has undergone a surface treatment 222 to promote bonding between the second cellulosic layer 220 and the compostable polymer based pattern bonded extrusion interlayer 216b. In embodiments, the treated surfaces 212 and 222, which may be the same or different treatments, are formed via flame treatment, corona treatment, plasma treatment, or ozone treatment. In preferred embodiments, the treated surfaces 212 and 222 are flame treated surfaces.

In embodiments, the first and second cellulosic layers 210 and 220, which may be the same or different, are formed of a paper material or a cellophane material as described above by way of reference to the first and second cellulosic layers 110 and 120 appearing in FIG. 1.

In embodiments, the first major surface of the first cellulosic layer 210 is configured to define an exterior facing surface of the structure 200b, i.e., the non-product-contacting side. In embodiments, the first major surface of the cellulosic layer 210 includes a printed indicia layer. In embodiments, the first cellulosic layer 210 is configured to impart dead fold or crease retention properties to the structure 200b.

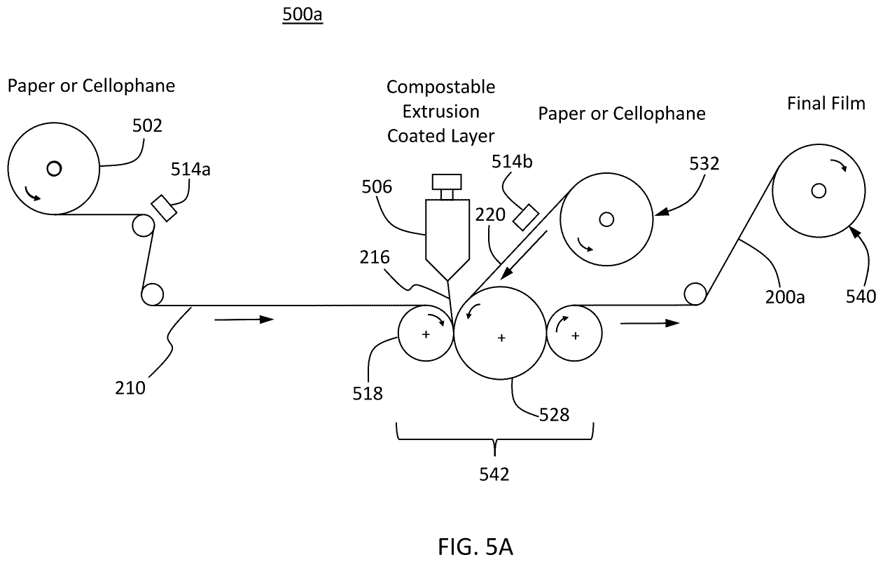

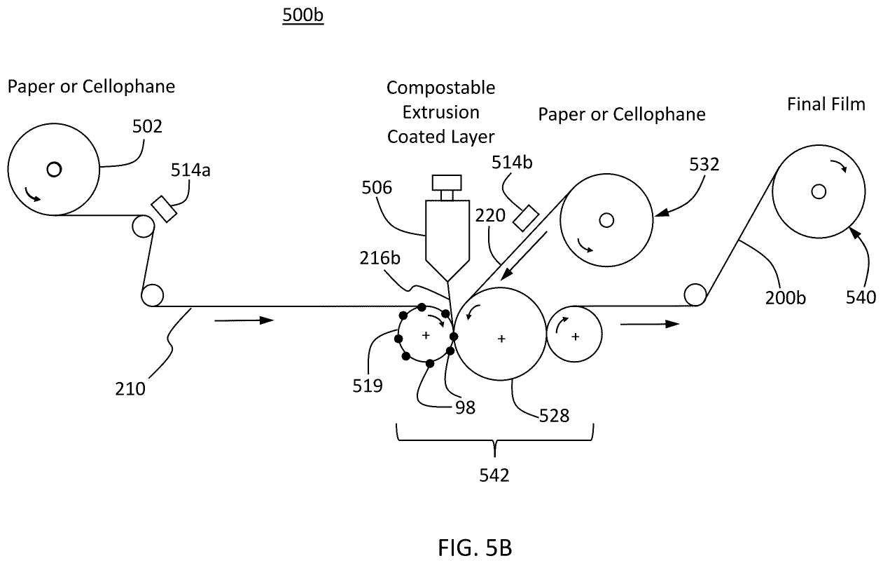

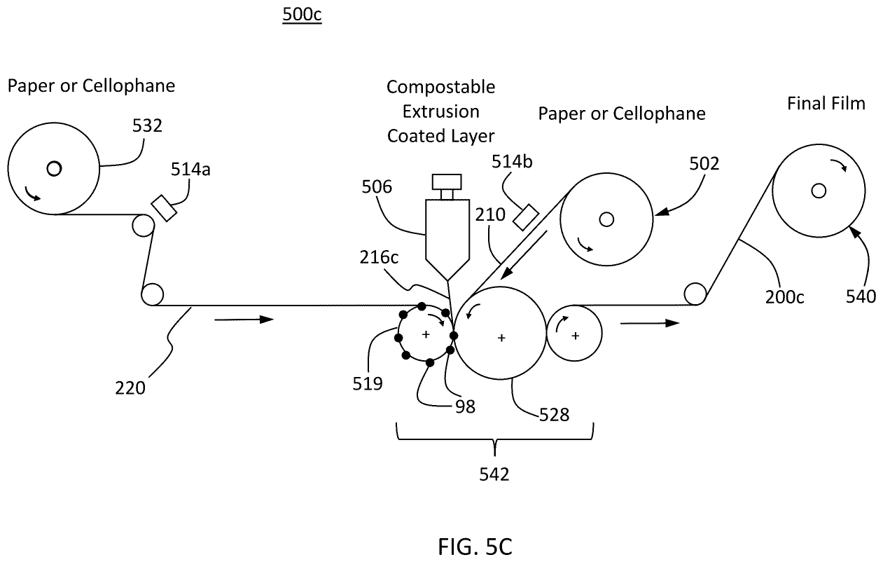

The compostable polymer based pattern bonded extrusion interlayer 216b is formed of a material as described above by way of reference to the compostable polymer layer 116 appearing in FIG. 1. As described below, the compostable polymer layer 116 is applied as a pattern bonded extruded interlayer between the first cellulosic layers 210, 220 as a molten film. In embodiments, the compostable polymer based pattern bonded extrusion interlayer 216b is applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer based pattern bonded extrusion interlayer 216b provides grease resistance, moisture barrier, and heat retention properties to the structure 200b. In the illustrated embodiment, the compostable polymer based pattern bonded extrusion interlayer 216b is applied as a pattern bonded extrusion interlayer, e.g., using a patterned lamination roller as described in greater detail below, such that the layer 216b is substantially continuously bonded to the surface 212 and is discontinuously or pattern bonded to the surface 222 such that air pockets 226 are formed adjacent to second cellulosic layer 220. The air pockets 226 impart insulative or heat retention properties to the structure 200b. As discussed in more detail with reference to FIG. 5B, pattern bonded regions 96 where localized pressure is applied by projection 98 on a patterned nip roll 519 exist adjacent to the unbonded air pockets 226.

In embodiments, the second cellulosic layer 220 is configured to be the interior layer of the structure 200b, i.e., the product-contacting side. In embodiments, the second cellulosic layer 220 is configured to impart dead fold or crease retention properties to the structure 200b. In embodiments, the second cellulosic layer 220 is configured to absorb excess moisture or grease from the product.

FIG. 2C is as described herein in connection with FIG. 2B. Structure 200c is similar to structure 200b except that compostable polymer pattern bonded extrusion interlayer 216b appearing in FIG. 2B is replaced with a compostable polymer pattern bonded extrusion interlayer 216c as shown in FIG. 2C. The compostable polymer pattern bonded extrusion interlayer 216c is substantially continuously bonded to the surface 222 of the substrate 220 and is pattern bonded to the surface 212 of the substrate 210, thereby defining air pockets 226 which are adjacent to the substrate layer 210. Pattern bonded regions 96 where localized pressure is applied by projection 98 on a patterned nip roll 519 exist adjacent to the unbonded air pockets 226.

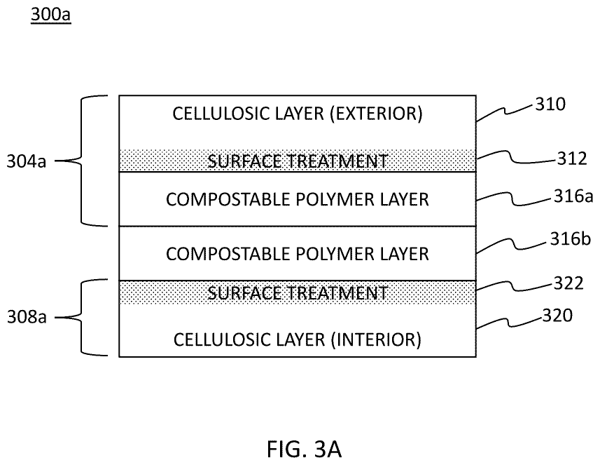

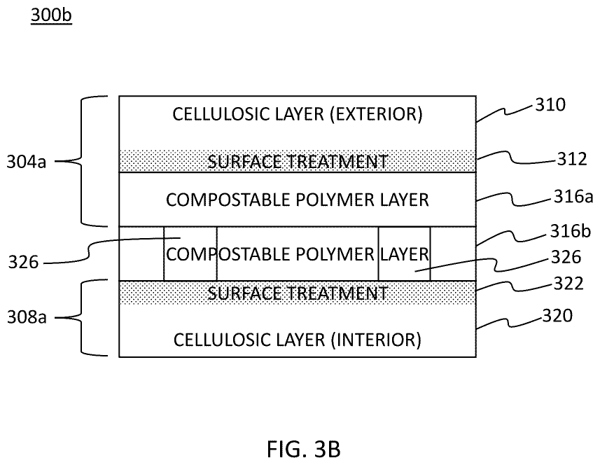

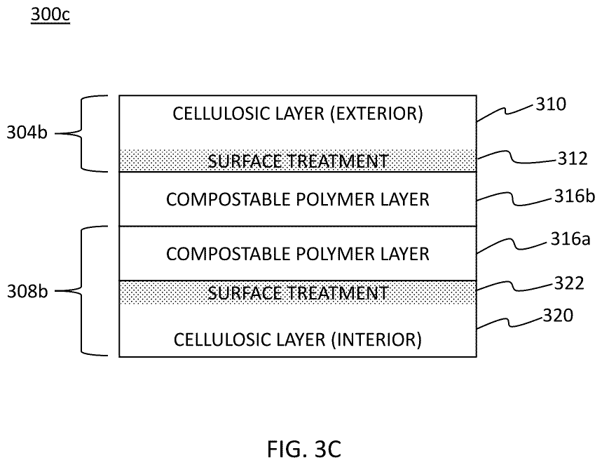

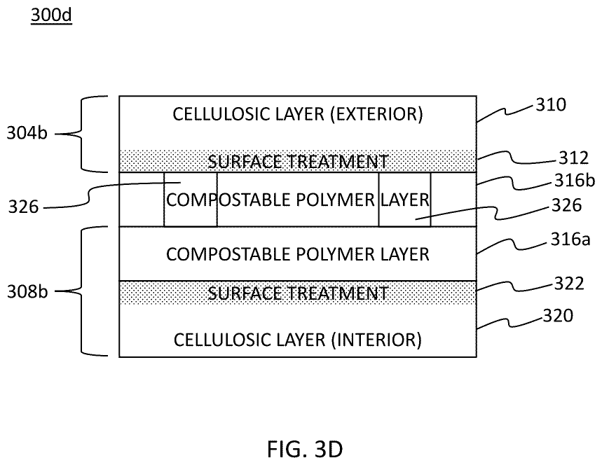

Referring now to FIG. 3A, a packaging structure 300a comprises a first ply 304a and a second ply 308a. The first ply 304a includes a first cellulosic layer 310, which has a first major surface, which is exterior facing, and a second major surface, which is interior facing and opposite the first major surface. The first ply 304a further includes a first compostable polymer layer 316a disposed on the second major surface of the first cellulosic layer 310. The first compostable polymer layer 316a forms an inner layer of the structure 300a. The second ply 308a comprises a second cellulosic layer 320, which has a first major surface, which is interior facing, and a second major surface, which is exterior facing and opposite the first major surface.

The first ply 304a and the second ply 308a are extrusion laminated to each other via a second compostable polymer layer 316b. The second compostable polymer layer 316b forms an inner layer of the structure 300a. The second major surface of the first cellulosic layer 310 is a surface which has undergone a surface treatment 312 to promote bonding between the first cellulosic layer 310 and the first compostable polymer layer 316a. The second major surface of the second cellulosic layer 320 is a surface which has undergone a surface treatment 322 to promote bonding between the second cellulosic layer 320 and the second compostable polymer layer 316b. In embodiments, the treated surfaces 312 and 322, which may be the same or different treatments, are formed via flame treatment, corona treatment, plasma treatment, or ozone treatment. In preferred embodiments, the treated surfaces 312 and 322 are flame treated surfaces.

In embodiments, the first and second cellulosic layers 310 and 320, which may be the same or different, are formed of a paper material or a cellophane material as described above by way of reference to the first and second cellulosic layers 110 and 120 appearing in FIG. 1.

In embodiments, the first major surface of the first cellulosic layer 310 is configured to define an exterior facing surface of the structure 300a, i.e., the non-product-contacting side. In embodiments, the first major surface of the cellulosic layer 310 includes a printed indicia layer. In embodiments, the first cellulosic layer 310 is configured to impart dead fold or crease retention properties to the structure 300a.

The compostable polymer layers 316a, 316b, which may be the same or different, are formed of a material as described above by way of reference to the compostable polymer layer 116 appearing in FIG. 1. As described below, the first compostable polymer layer 316a is extrusion coated onto the treated, second major surface 312 of the first cellulosic layer 310 to form the first ply 304a. As described below, the second compostable polymer layer 316b is extruded between the first ply 304a and the second cellulosic layer 320 as a molten film to form an extrusion interlayer. In embodiments, each of the compostable polymer layers 316a, 316b are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. In embodiments, the compostable polymer layers 316a, 316b taken together are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layers 316a, 316b provide grease resistance, moisture barrier, and heat retention properties to the structure 300a. In the illustrated embodiment, the compostable polymer layers 316a and 316b are each applied as continuous extrusions.

In embodiments, the second cellulosic layer 320 is configured to be the interior layer of the structure 300a, i.e., the product-contacting side. In embodiments, the second cellulosic layer 320 is configured to impart dead fold or crease retention properties to the structure 300a. In embodiments, the second cellulosic layer 320 is configured to absorb excess moisture or grease from the product.

Referring now to FIG. 3B, a packaging structure 300b comprises a first ply 304a and a second ply 308a. The first ply 304a includes a first cellulosic layer 310, which has a first major surface, which is exterior facing, and a second major surface, which is interior facing and opposite the first major surface. The first ply 304a further includes a first compostable polymer layer 316a disposed on the second major surface of the first cellulosic layer 310. The first compostable polymer layer 316a forms an inner layer of the structure 300b. The second ply 308a comprises a second cellulosic layer 320, which has a first major surface, which is interior facing, and a second major surface, which is exterior facing and opposite the first major surface.

The first ply 304a and the second ply 308a are extrusion laminated to each other via a second compostable polymer layer 316b. The second compostable polymer layer 316b forms an inner layer of the structure 300b. The second major surface of the first cellulosic layer 310 is a surface which has undergone a surface treatment 312 to promote bonding between the first cellulosic layer 310 and the first compostable polymer layer 316a. The second major surface of the second cellulosic layer 320 is a surface which has undergone a surface treatment 322 to promote bonding between the second cellulosic layer 320 and the second compostable polymer layer 316b. In embodiments, the treated surfaces 312 and 322, which may be the same or different treatments, are formed via flame treatment, corona treatment, plasma treatment, or ozone treatment. In preferred embodiments, the treated surfaces 312 and 322 are flame treated surfaces.

In embodiments, the first and second cellulosic layers 310 and 320, which may be the same or different, are formed of a paper material or a cellophane material as described above by way of reference to the first and second cellulosic layers 110 and 120 appearing in FIG. 1.

In embodiments, the first major surface of the first cellulosic layer 310 is configured to define an exterior facing surface of the structure 300b, i.e., the non-product-contacting side. In embodiments, the first major surface of the cellulosic layer 310 includes a printed indicia layer. In embodiments, the first cellulosic layer 310 is configured to impart dead fold or crease retention properties to the structure 300b.

The compostable polymer layers 316a, 316b, which may be the same or different, are formed of a material as described above by way of reference to the compostable polymer layer 116 appearing in FIG. 1. As described below, the first compostable polymer layer 316a is extrusion coated onto the treated, second major surface 312 of the first cellulosic layer 310 to form the first ply 304a. As described below, the second compostable polymer layer 316b is extruded between the first ply 304a and the second cellulosic layer 320 as a molten film in an extrusion lamination process to form an extrusion interlayer. In embodiments, each of the compostable polymer layers 316a, 316b are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. In embodiments, the compostable polymer layers 316a, 316b taken together are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layers 316a, 316b provide grease resistance, moisture barrier, and heat retention properties to the structure 300b. In the illustrated embodiment, the compostable polymer layer 316a is applied as a continuous extrusion. In the illustrated embodiment, the compostable polymer layer 316b is applied as a discontinuous extrusion such that air pockets 326 are defined between the second cellulosic layer 320 and the first compostable polymer layer 316a. The air pockets 326 impart insulative or heat retention properties to the structure 300b.

In embodiments, the second cellulosic layer 320 is configured to be the interior layer of the structure 300b, i.e., the product-contacting side. In embodiments, the second cellulosic layer 320 is configured to impart dead fold or crease retention properties to the structure 300b. In embodiments, the second cellulosic layer 320 is configured to absorb excess moisture or grease from the product.

Referring now to FIG. 3C, a packaging structure 300c comprises a first ply 304b and a second ply 308b. The first ply 304b includes a first cellulosic layer 310, which has a first major surface, which is exterior facing, and a second major surface, which is interior facing and opposite the first major surface. The second ply 308b comprises a second cellulosic layer 320, which has a first major surface, which is interior facing, and a second major surface, which is exterior facing and opposite the first major surface. The second ply 308b further includes a first compostable polymer layer 316a disposed on the second major surface of the second cellulosic layer 320. The first compostable polymer layer 316a forms an inner layer of the structure 300c.

The first ply 304b and the second ply 308b are extrusion laminated to each other via a second compostable polymer layer 316b. The second compostable polymer layer 316b forms an inner layer of the structure 300c. The second major surface of the second cellulosic layer 320 is a surface which has undergone a surface treatment 322 to promote bonding between the second cellulosic layer 320 and the first compostable polymer layer 316a. The second major surface of the first cellulosic layer 310 is a surface which has undergone a surface treatment 312 to promote bonding between the first cellulosic layer 310 and the second compostable polymer layer 316b. In embodiments, the treated surfaces 312 and 322, which may be the same or different treatments, are formed via flame treatment, corona treatment, plasma treatment, or ozone treatment. In preferred embodiments, the treated surfaces 312 and 322 flame treated surfaces. In preferred embodiments, the treated surfaces 312 and 322 are flame treated surfaces.

In embodiments, the first and second cellulosic layers 310 and 320, which may be the same or different, are formed of a paper material or a cellophane material as described above by way of reference to the first and second cellulosic layers 110 and 120 appearing in FIG. 1.

In embodiments, the first major surface of the first cellulosic layer 310 is configured to define an exterior facing surface of the structure 300c, i.e., the non-product-contacting side. In embodiments, the first major surface of the cellulosic layer 310 includes a printed indicia layer. In embodiments, the first cellulosic layer 310 is configured to impart dead fold or crease retention properties to the structure 300c.

The compostable polymer layers 316a, 316b, which may be the same or different, are formed of a material as described above by way of reference to the compostable polymer layer 116 appearing in FIG. 1. As described below, the first compostable polymer layer 316a is extrusion coated onto the treated, second major surface 322 of the second cellulosic layer 320 to form the second ply 308b. As described below, the second compostable polymer layer 316b is extruded between the second ply 308b and the first cellulosic layer 310 as a molten film in an extrusion lamination process to form an extrusion interlayer. In embodiments, each of the compostable polymer layers 316a, 316b are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. In embodiments, the compostable polymer layers 316a, 316b taken together are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layers 316a, 316b provide grease resistance, moisture barrier, and heat retention properties to the structure 300c. In the illustrated embodiment, the compostable polymer layers 316a and 316b are applied as continuous extrusions.

In embodiments, the second cellulosic layer 320 is configured to be the interior layer of the structure 300c, i.e., the product-contacting side. In embodiments, the second cellulosic layer 320 is configured to impart dead fold or crease retention properties to the structure 300c. In embodiments, the second cellulosic layer 320 is configured to absorb excess moisture or grease from the product.

Referring now to FIG. 3D, a packaging structure 300d comprises a first ply 304b and a second ply 308b. The first ply 304b includes a first cellulosic layer 310, which has a first major surface, which is exterior facing, and a second major surface, which is interior facing and opposite the first major surface. The second ply 308b comprises a second cellulosic layer 320, which has a first major surface, which is interior facing, and a second major surface, which is exterior facing and opposite the first major surface. The second ply 308b further includes a first compostable polymer layer 316a disposed on the second major surface of the second cellulosic layer 320. The first compostable polymer layer 316a forms an inner layer of the structure 300d.

The first ply 304b and the second ply 308b are extrusion laminated to each other via a second compostable polymer layer 316b. The second compostable polymer layer 316b forms an inner layer of the structure 300d. The second major surface of the second cellulosic layer 320 is a surface which has undergone a surface treatment 322 to promote bonding between the second cellulosic layer 320 and the first compostable polymer layer 316a. The second major surface of the first cellulosic layer 310 is a surface which has undergone a surface treatment 312 to promote bonding between the first cellulosic layer 310 and the second compostable polymer layer 316b. In embodiments, the treated surfaces 312 and 322, which may be the same or different treatments, are formed via flame treatment, corona treatment, plasma treatment, or ozone treatment. In preferred embodiments, the treated surfaces 312 and 322 are flame treated surfaces.

In embodiments, the first and second cellulosic layers 310 and 320, which may be the same or different, are formed of a paper material or a cellophane material as described above by way of reference to the first and second cellulosic layers 110 and 120 appearing in FIG. 1.

In embodiments, the first major surface of the first cellulosic layer 310 is configured to define an exterior facing surface of the structure 300d, i.e., the non-product-contacting side. In embodiments, the first major surface of the cellulosic layer 310 includes a printed indicia layer. In embodiments, the first cellulosic layer 310 is configured to impart dead fold or crease retention properties to the structure 300d.

The compostable polymer layers 316a, 316b, which may be the same or different, are formed of a material as described above by way of reference to the compostable polymer layer 116 appearing in FIG. 1. As described below, the first compostable polymer layer 316a is extrusion coated onto the treated, second major surface 322 of the second cellulosic layer 320 to form the second ply 308b. As described below, the second compostable polymer layer 316b is extruded between the second ply 308b and the first cellulosic layer 310 as a molten film in an extrusion lamination process to form an extrusion interlayer. In embodiments, each of the compostable polymer layers 316a, 316b are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. In embodiments, the compostable polymer layers 316a, 316b taken together are applied at a coating weight in the range of 2 #/ream to 25 #/ream, e.g., 2 #/ream, 3 #/ream, 4 #/ream, 5 #/ream, 6 #/ream, 7 #/ream, 8 #/ream, 9 #/ream, 10 #/ream, 11 #/ream, 12 #/ream, 13 #/ream, 14 #/ream, 15 #/ream, 16 #/ream, 17 #/ream, 18 #/ream, 19 #/ream, 20 #/ream, 21 #/ream, 22 #/ream, 23 #/ream, 24 #/ream, or 25 #/ream. In preferred embodiments, the compostable polymer layer 116 is applied at a coating weight in the range of 4 #/ream to 15 #/ream. The compostable polymer layers 316a, 316b provide grease resistance, moisture barrier, and heat retention properties to the structure 300d. In the illustrated embodiment, the first compostable polymer layer 316a is applied as a continuous extrusion and the second compostable polymer layer 316b is applied as a discontinuous extrusion such that air pockets 326 are defined between the first cellulosic layer 310 and the first compostable polymer layer 316a. The air pockets 326 impart insulative or heat retention properties to the structure 300d.

In embodiments, the second cellulosic layer 320 is configured to be the interior layer of the structure 300d, i.e., the product-contacting side. In embodiments, the second cellulosic layer 320 is configured to impart dead fold or crease retention properties to the structure 300d. In embodiments, the second cellulosic layer 320 is configured to absorb excess moisture or grease from the product.

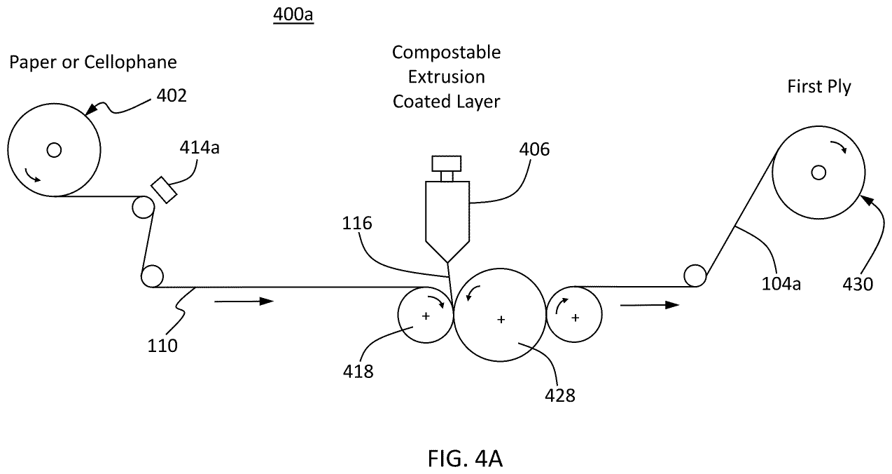

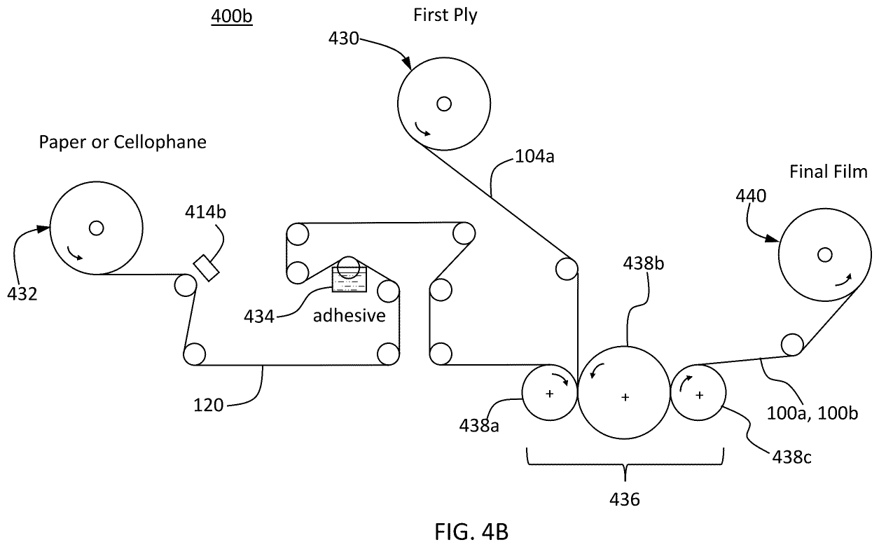

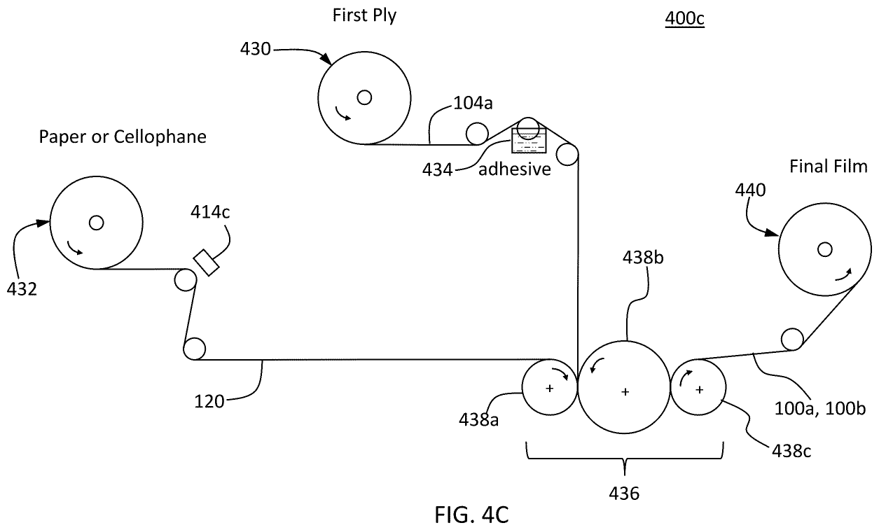

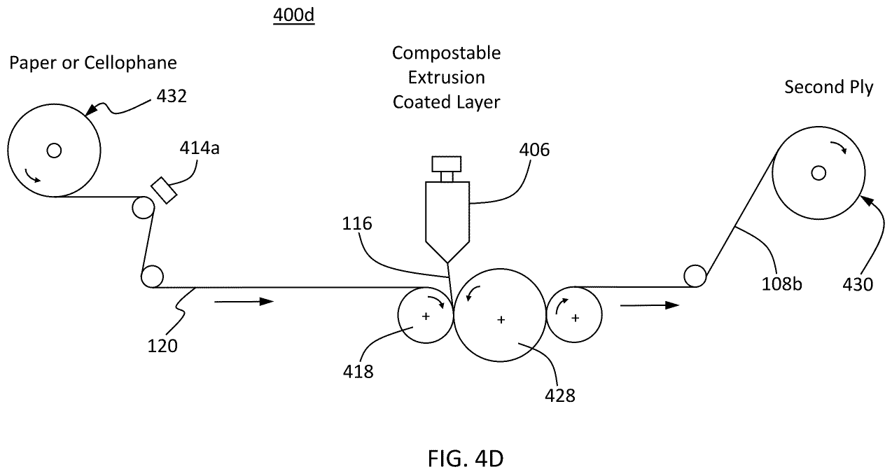

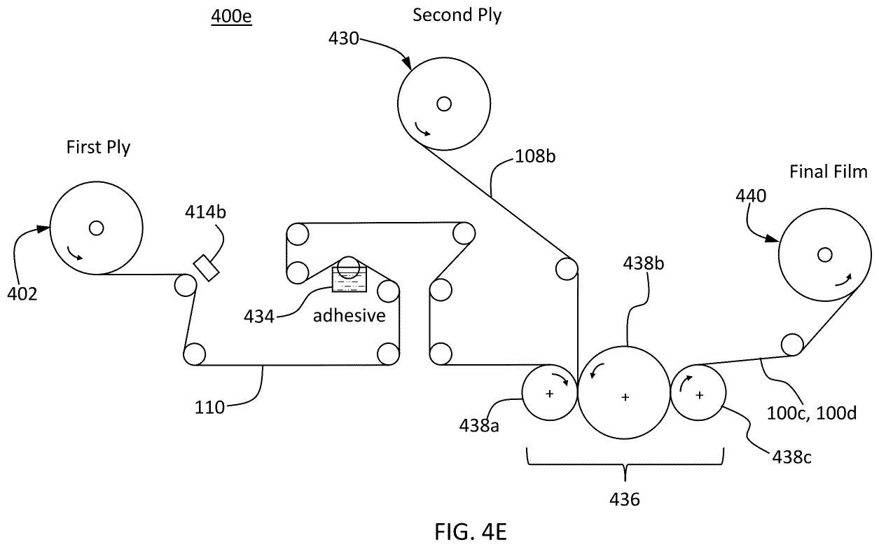

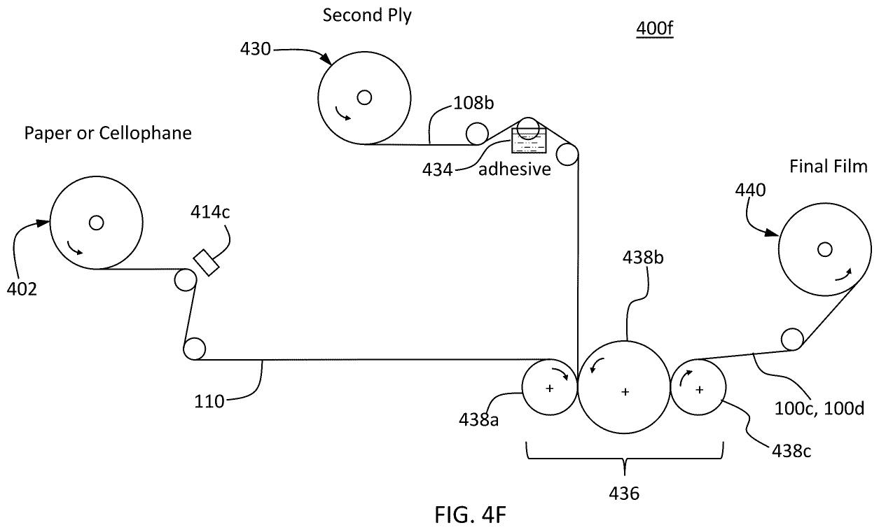

Referring now to FIG. 4A, a manufacturing line 400a for making the first ply portion 104a of the packaging structures 100a and 100b is illustrated. The line 400a illustrated is suitable for making the first ply portion 104a of FIGS. 1A and 1B described above. The line 400a includes a substrate roll 402 comprising the cellulosic substrate 110. The cellulosic substrate 110 may have an optional printed ink layer pre-printed or pre-applied to the first major surface of the cellulosic substrate 110.

The cellulosic substrate 110 is unrolled from the substrate roll 402 and fed toward an extrusion coater 406 which coats the second major surface of the cellulosic substrate 110 with the compostable polymer layer 116. On the way to the coextrusion coater 406, the cellulosic substrate 110 from the substrate roll 402 is fed past a surface treatment station 414a, such as a flame treater, corona treater, plasma treater, or ozone treater that treats the second major surface of the paper substrate 110 such that the compostable polymer layer 116 created at the extrusion coater 406 will adhere well to the treated surface 112 of the substrate 110. In preferred embodiments, the surface treatment station 414a comprises a flame treater.

At the extrusion coater 406, the substrate 110 is fed through a nip point at which point the compostable polymer layer 116 is applied onto the substrate 110 as a melt curtain. The nip point occurs between a nip roll 418 and a chill roll 428. The compostable polymer material is extruded by a die of the extrusion coater 406 proximate the nip point and is cooled by the chill roll 428 to bond the compostable polymer layer 116 to the treated surface 112 of the substrate 110 to form the first ply structure 104a. The first ply structure 104a is then wound up on a product wind-up roll 430.

Referring now to FIG. 4B, there is shown a process line 400b for making the film structures 100a and 100b. The line 400b illustrated is suitable for making the film structures 100a and 100b described above. The cellulosic substrate 120 comprising the second ply 108a is unrolled from a substrate roll 432 and fed toward an adhesive coating station 434 which coats the second major surface of the cellulosic substrate 120 with an adhesive. In embodiments, the adhesive is applied as a continuous adhesive layer 124a to ultimately produce the structure 100a. In embodiments, the adhesive is applied as a patterned or otherwise discontinuous adhesive layer 124b to ultimately produce the structure 100b. In embodiments, the adhesive coating station 434 comprises a roll coater, spray coater, slot-die coater, gravure coater, flexographic coater, or the like.

On the way to the adhesive coating station 434, the cellulosic substrate 120 from the substrate roll 432 is fed past a surface treatment station 414b, such as a flame treater, corona treater, plasma treater, or ozone treater that treats the second major surface of the paper substrate 120 such that the adhesive layer 124a, 124b applied at the adhesive coating station 434 will adhere well to the treated surface 122 of the substrate 120. In preferred embodiments, the surface treatment station 414b comprises a flame treater. The adhesive coated substrate 120 is then fed into an adhesive laminating station 436.

Meanwhile, the first ply structure 104a is unwound from the wind-up roll 430 and fed into the adhesive laminating station 436. The substrate 120 and first ply 104a come together and pass through a series of rollers, e.g., 438a, 438b, 438c, that apply pressure to bond the substrate 120 and first ply 104a together for forming the film structure 100a or 100b. In embodiments, the rollers 438a, 438b, 438c are heated to activate the adhesive and ensure a strong bond. The laminated film structure 100a, 100b is then wound onto a finished product roll 440.

Referring now to FIG. 4C, there is shown an alternative process line 400c for making the film structure 100a or 100b. The line 400c illustrated is suitable for making the film structures 100a and 100b described above. The first ply 104a is unrolled from the substrate roll 430 and fed toward an adhesive coating station 434 which coats the compostable polymer surface 116 of the first ply 104a with the adhesive layer. In embodiments, the adhesive is applied as a continuous adhesive layer 124a to ultimately produce the structure 100a. In embodiments, the adhesive is applied as a patterned or otherwise discontinuous adhesive layer 124b to ultimately produce the structure 100b. In embodiments, the adhesive coating station 434 comprises a roll coater, spray coater, slot-die coater, gravure coater, flexographic coater, or the like. The adhesive coated first ply 104a is then fed into an adhesive laminating station 436.

Meanwhile, the cellulosic substrate 120 comprising the second ply 108a is unwound from a substrate roll 432 and fed into the adhesive laminating station 436. On the way to the adhesive laminating station 436, the cellulosic substrate 120 from the substrate roll 432 is fed past a surface treatment station 414c, such as a flame treater, corona treater, plasma treater, or ozone treater that treats the second major surface of the paper substrate 120 such that the adhesive layer 124a or 124b applied to the first ply 104a will adhere well to the treated surface 122 of the substrate 120. In preferred embodiments, the surface treatment station 414c comprises a flame treater.

The substrate 120 and the adhesive-coated first ply 104a come together and pass through a series of rollers, e.g., 438a, 438b, 438c, that apply pressure to bond the substrate 120 and first ply 104a together for forming the film structure 100a or 100b. In embodiments, the rollers 438a, 438b, 438c are heated to activate the adhesive and ensure a strong bond. The laminated film structure 100a, 100b is then wound onto a finished product roll 440.

Referring now to FIG. 4D, a manufacturing line 400d for making the second ply portion 108b of the packaging structures 100c and 100d is illustrated. The line 400d illustrated is suitable for making the second ply portion 108b of FIGS. 1C and 1D as described above. The line 400d includes a substrate roll 432 comprising the cellulosic substrate 120.

The cellulosic substrate 120 is unrolled from the substrate roll 432 and fed toward an extrusion coater 406 which coats the second major surface of the cellulosic substrate 120 with the compostable polymer layer 116. On the way to the coextrusion coater 406, the cellulosic substrate 120 from the substrate roll 432 is fed past a surface treatment station 414a, such as a flame treater, corona treater, plasma treater, or ozone treater that treats the second major surface of the paper substrate 120 such that the compostable polymer layer 116 created at the extrusion coater 406 will adhere well to the treated surface 122 of the substrate 120. In preferred embodiments, the surface treatment station 414a comprises a flame treater.

At the extrusion coater 406, the substrate 120 is fed through a nip point at which point the compostable polymer layer 116 is applied onto the substrate 120 as a melt curtain. The nip point occurs between a nip roll 418 and a chill roll 428. The compostable polymer material is extruded by a die of the extrusion coater 406 proximate the nip point and is cooled by the chill roll 428 to bond the compostable polymer layer 116 to the treated surface 122 of the substrate 120 to form the second ply structure 108b. The second ply structure 108b is then wound up on a product wind-up roll 430.

Referring now to FIG. 4E, there is shown a process line 400e for making the film structures 100c and 100d. The line 400e illustrated is suitable for making the film structures 100c and 100d described above. The cellulosic substrate 110 comprising the first ply 104b is unrolled from a substrate roll 402 and fed toward an adhesive coating station 434 which coats the second major surface of the cellulosic substrate 110 with the adhesive. In embodiments, the adhesive is applied as a continuous adhesive layer 124a to ultimately produce the structure 100c. In embodiments, the adhesive is applied as a patterned or otherwise discontinuous adhesive layer 124b to ultimately produce the structure 100d. In embodiments, the adhesive coating station 434 comprises a roll coater, spray coater, slot-die coater, gravure coater, flexographic coater, or the like.

On the way to the adhesive coating station 434, the cellulosic substrate 110 from the substrate roll 402 is fed past a surface treatment station 414b, such as a flame treater, corona treater, plasma treater, or ozone treater that treats the second major surface of the paper substrate 110 such that the adhesive layer 124a, 124b applied at the adhesive coating station 434 will adhere well to the treated surface 112 of the substrate 110. In preferred embodiments, the surface treatment station 414b comprises a flame treater. The adhesive coated substrate 110 is then fed into an adhesive laminating station 436.

Meanwhile, the second ply structure 108b is unwound from the roll 430 and fed into the adhesive laminating station 436. The substrate 110 and second ply 108b come together and pass through a series of rollers, e.g., 438a, 438b, 438c, that apply pressure to bond the substrate 110 and second ply 108b together for forming the film structure 100c, 100d. In embodiments, the rollers 438a, 438b, 438c are heated to activate the adhesive and ensure a strong bond. The laminated film structure 100c, 100d is then wound onto a finished product roll 440.

Referring now to FIG. 4F, there is shown an alternative process line 400f for making the film structure 100c or 100d. The line 400f illustrated is suitable for making the film structures 100c and 100d described above. The second ply 108b is unrolled from the substrate roll 430 and fed toward an adhesive coating station 434 which coats the compostable polymer surface 116 of the second ply 108b with an adhesive. In embodiments, the adhesive is applied as a continuous adhesive layer 124a to ultimately produce the structure 100c. In embodiments, the adhesive is applied as a patterned or otherwise discontinuous adhesive layer 124b to ultimately produce the structure 100d. In embodiments, the adhesive coating station 434 comprises a roll coater, spray coater, slot-die coater, gravure coater, flexographic coater, or the like. The adhesive coated second ply 108b is then fed into an adhesive laminating station 436.

Meanwhile, the cellulosic substrate 110 comprising the first ply 104b is unwound from a substrate roll 402 and fed into the adhesive laminating station 436. On the way to the adhesive laminating station 436, the cellulosic substrate 110 from the substrate roll 402 is fed past a surface treatment station 414c, such as a flame treater, corona treater, plasma treater, or ozone treater that treats the second major surface of the paper substrate 110 such that the adhesive layer 124a or 124b applied to the second ply 108b will adhere well to the treated surface 112 of the substrate 110. In preferred embodiments, the surface treatment station 414c comprises a flame treater.

The substrate 110 and the adhesive-coated second ply 108b come together and pass through a series of rollers, e.g., 438a, 438b, 438c, that apply pressure to bond the substrate 110 and second ply 108b together for forming the film structure 100c or 100d. In embodiments, the rollers 438a, 438b, 438c are heated to activate the adhesive and ensure a strong bond. The laminated film structure 100c, 100d is then wound onto a finished product roll 440.

Referring now to FIG. 5A, a manufacturing line 500a for making the packaging structure 200a is illustrated. The line 500a illustrated is suitable for making the packaging structure 200a as described above. The line 500a includes a first substrate roll 502 comprising the cellulosic substrate 210 and a second substrate roll 540 comprising the cellulosic substrate 220. The cellulosic substrate 210 may have an optional printed ink layer pre-printed or pre-applied to the first major surface of the cellulosic substrate 210.

The cellulosic substrate 210 is unrolled from the first substrate roll 502 and fed toward an extrusion lamination station 542 comprising an extruder 506. On the way to the extrusion lamination station 542, the cellulosic substrate 210 from the substrate roll 502 is fed past a surface treatment station 514a, such as a flame treater, corona treater, plasma treater, or ozone treater that treats the second major surface of the paper substrate 210 such that the compostable polymer layer 216 created at the extrusion laminator 506 will adhere well to the treated surface 212 of the substrate 210. In preferred embodiments, the surface treatment station 514a comprises a flame treater.

Meanwhile, the cellulosic substrate 220 is unwound from a second substrate roll 532 and fed toward the extrusion lamination station 542. On the way to the extrusion lamination station 542, the cellulosic substrate 220 from the substrate roll 532 is fed past a surface treatment station 514b, such as a flame treater, corona treater, plasma treater, or ozone treater that treats the second major surface of the paper substrate 220 such that the compostable polymer layer 216 created at the extrusion laminator 506 will adhere well to the treated surface 222 of the substrate 220. In preferred embodiments, the surface treatment station 514b comprises a flame treater.

At the extrusion lamination station 542, the surface treated substrates 210 and 220 come together and are fed through a nip point at which point the compostable polymer layer 216 is applied between the substrates 210 and 220 as a melt curtain. The nip point occurs between a nip roll 518 and a chill roll 528. The compostable polymer material is extruded by a die of the extrusion coater 506 proximate the nip point and is cooled by the chill roll 528. The compostable polymer layer 216 forms an extrusion interlayer which bonds the compostable polymer layer 216 to the treated surface 212 of the substrate 210 and to the treated surface 222 of the substrate 220 to form the structure 200a. The structure 200a is then wound up on a final product wind-up roll 540.

Referring now to FIG. 5B, a manufacturing line 500b for making the packaging structure 200b is illustrated. The line 500b illustrated is suitable for making the packaging structure 200b as described above. The line 500b includes a first substrate roll 502 comprising the cellulosic substrate 210 and a second substrate roll 540 comprising the cellulosic substrate 220. The cellulosic substrate 210 may have an optional printed ink layer pre-printed or pre-applied to the first major surface of the cellulosic substrate 210.

The cellulosic substrate 210 is unrolled from the first substrate roll 502 and fed toward an extrusion lamination station 542 comprising an extruder 506. On the way to the extrusion lamination station 542, the cellulosic substrate 210 from the substrate roll 502 is fed past a surface treatment station 514a, such as a flame treater, corona treater, plasma treater, or ozone treater that treats the second major surface of the paper substrate 210 such that the compostable polymer based pattern bonded extrusion interlayer 216b created at the extrusion laminator 506 will adhere well to the treated surface 212 of the substrate 210. In preferred embodiments, the surface treatment station 514a comprises a flame treater.

Meanwhile, the cellulosic substrate 220 is unwound from a second substrate roll 532 and fed toward the extrusion lamination station 542. On the way to the extrusion lamination station 542, the cellulosic substrate 220 from the substrate roll 532 is fed past a surface treatment station 514b, such as a flame treater, corona treater, plasma treater, or ozone treater that treats the second major surface of the paper substrate 220 such that the compostable polymer based pattern bonded extrusion interlayer 216b created at the extrusion laminator 506 will adhere well to the treated surface 222 of the substrate 220. In preferred embodiments, the surface treatment station 514b comprises a flame treater.

At the extrusion lamination station 542, the surface treated substrates 210 and 220 come together and are fed through a nip point at which point the compostable polymer based pattern bonded extrusion interlayer 216b is applied between the substrates 210 and 220 as a melt curtain.

The nip point occurs between a patterned nip roll 519 and a chill roll 528. The patterned nip roll 519 includes raised areas or projections 98 which apply localized pressure at discrete regions 96, thereby selectively bonding the substrates 210 and 220 in the regions 96 to form a pattern bonded interface between the substrates 210 and 220. The patterned nip roll 519 may be constructed of any suitable material, including rigid materials such as metals, resilient materials such as polymers, or a combination thereof. In embodiments, the surface of the patterned nip roll 519 defines a pattern of raised projections 98 operative to impart a corresponding pattern of localized pressure to the substrates being laminated. The patterned surface may be produced by machining, casting, additive manufacturing techniques, or by mounting a patterned sleeve over a cylindrical roller.

The patterned nip roll 519 may include projections 98 that are configured to produce any suitable bond pattern. As used herein, the term patterned bonding encompasses any arrangement of thermally bonded regions, regardless of the specific geometry, orientation, or interconnection of the bond elements. In certain embodiments, the bond pattern includes elements which may be linear, curvilinear, continuous, segmented, and may be arranged to intersect, overlap, or remain discrete from one another. The pattern may define any desired geometry or combination of geometries, including straight or curved lines, dots, polygons, grids, or other shapes. The bond pattern may be regular or irregular, continuous or discontinuous, and may extend uniformly or vary across the web.

In embodiments, the melt curtain is applied so that it substantially continuously covers the surface 212 of the layer 210, wherein the air pocket regions 226 are formed adjacent to the pattern bonded regions 96, where the compostable polymer based pattern bonded extrusion interlayer 216b remains unbonded to the cellulosic layer 220, thereby defining bonded and unbonded areas 96 and 226, respectively, across the packaging structure 200b. The air pockets 226 exhibit low thermal conductivity, impede heat transfer, and increase the thermal resistance of the packaging structure 200b.

In certain embodiments, the bonded regions 96 collectively occupy a projected area which is in the range of from about 5% to about 99% of the total projected area of the web, e.g., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or any subrange or subset thereof. As used herein, the term “projected area” refers to the planar area of the web, as seen in projection onto a plane, without accounting for surface roughness or texture.

The compostable polymer material is extruded by a die of the extrusion coater 506 proximate the nip point and is cooled by the chill roll 528. The compostable polymer based pattern bonded extrusion interlayer 216b forms a pattern bonded extrusion interlayer which bonds the compostable polymer based pattern bonded extrusion interlayer 216b to the treated surface 212 of the substrate 210 and to the treated surface 222 of the substrate 220 to form the structure 200b. The structure 200b is then wound up on a final product wind-up roll 540.

FIG. 5C is as described herein in connection with FIG. 5B, except and the positions of the substrates 210 and 220 are exchanged so that the compostable polymer pattern bonded extrusion interlayer 216c is substantially continuously bonded to the surface 222 of the substrate 220 and wherein the compostable polymer pattern bonded extrusion interlayer 216c is pattern bonded to the surface 212 of the substrate 210, thereby forming air pockets 226 which are adjacent to the substrate layer 210.

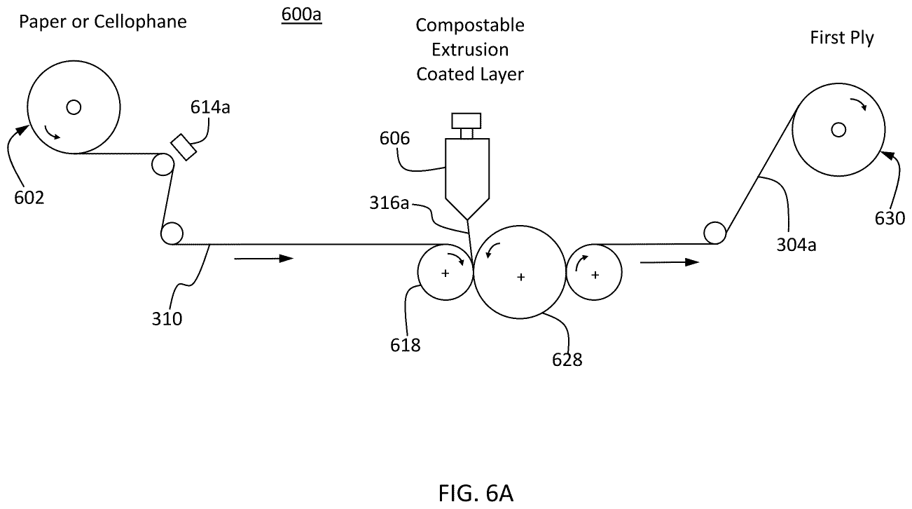

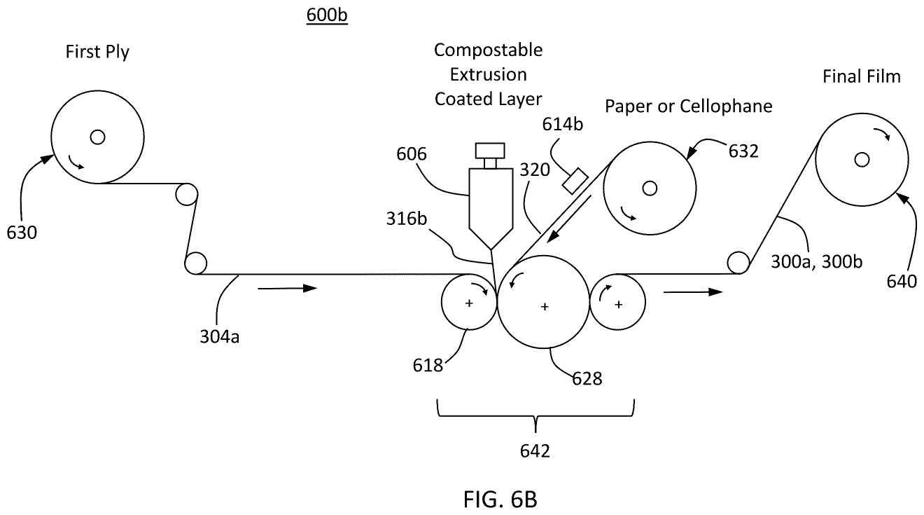

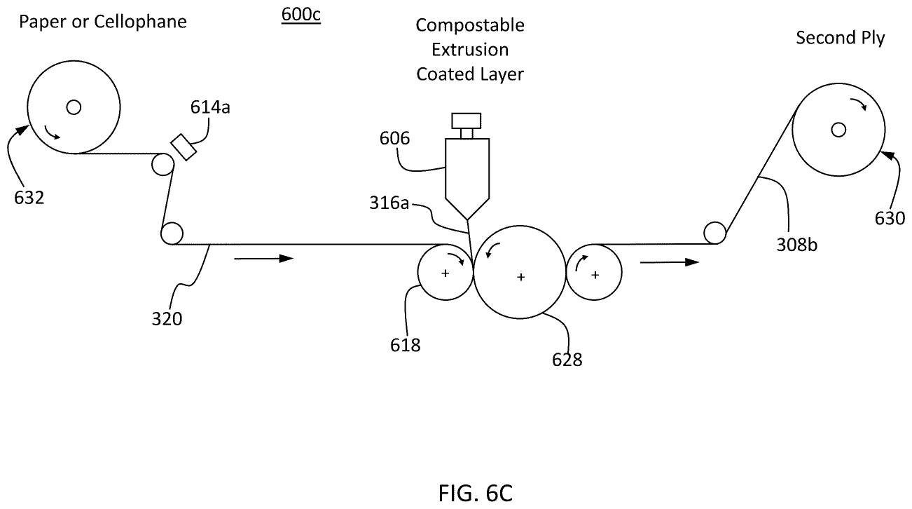

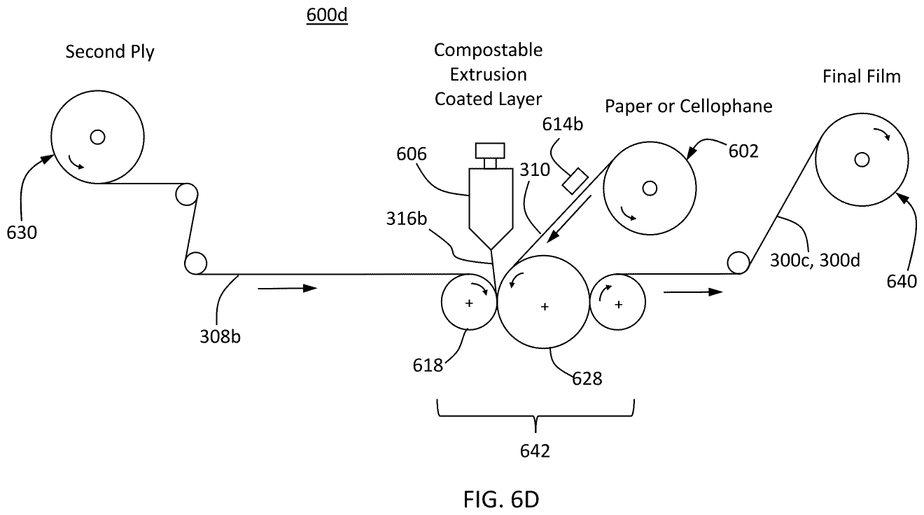

Referring now to FIG. 6A, a manufacturing line 600a for making the first ply portion 304a of the packaging structure 300a or 300b is illustrated. The line 600a illustrated is suitable for making the first ply portion 304a of FIGS. 3A and 3B described above. The line 600a includes a substrate roll 602 comprising the cellulosic substrate 310. The cellulosic substrate 310 may have an optional printed ink layer pre-printed or pre-applied to the first major surface of the cellulosic substrate 310.

The cellulosic substrate 310 is unrolled from the substrate roll 602 and fed toward an extrusion coater 606 which coats the second major surface of the cellulosic substrate 310 with the first compostable polymer layer 316a. On the way to the coextrusion coater 606, the cellulosic substrate 310 from the substrate roll 602 is fed past a surface treatment station 614a, such as a flame treater, corona treater, plasma treater, or ozone treater that treats the second major surface of the paper substrate 310 such that the compostable polymer layer 316a created at the extrusion coater 606 will adhere well to the treated surface 312 of the substrate 310. In preferred embodiments, the surface treatment station 614a comprises a flame treater.

At the extrusion coater 606, the substrate 310 is fed through a nip point at which point the compostable polymer layer 316a is applied onto the substrate 310 as a melt curtain. The nip point occurs between a nip roll 618 and a chill roll 628. The compostable polymer material is extruded by a die of the extrusion coater 606 proximate the nip point and is cooled by the chill roll 628 to bond the compostable polymer layer 316a to the treated surface 312 of the substrate 310 to form the first ply structure 304a. The first ply structure 304a is then wound up on a product wind-up roll 630.

Referring now to FIG. 6B, there is shown a process line 600b for making the film structures 300a and 300b. The line 600b illustrated is suitable for making the film structures 300a and 300b described above. The cellulosic substrate 320 comprising the second ply 308a is unrolled from a substrate roll 632 and fed toward an extrusion lamination station 642 comprising an extruder 606. On the way to the extrusion lamination station 642, the cellulosic substrate 320 from the substrate roll 632 is fed past a surface treatment station 614b, such as a flame treater, corona treater, plasma treater, or ozone treater that treats the second major surface of the paper substrate 320 such that the compostable polymer layer 316b created at the extrusion laminator 606 will adhere well to the treated surface 322 of the substrate 320. In preferred embodiments, the surface treatment station 614b comprises a flame treater.

Meanwhile, the first ply structure 304a is unwound from the roll 630 and fed into the extrusion lamination station 642. The substrate 320 and first ply 304a come together and pass through a nip point at which point the compostable polymer layer 316b is extruded between the first ply structure 304a and substrate 320 as a melt curtain. The nip point occurs between a nip roll 618 and a chill roll 628. The compostable polymer material is extruded by a die of the extrusion coater 606 proximate the nip point and is cooled by the chill roll 628 to form the structure 300a or 300b. In embodiments, the compostable polymer layer 316b is applied as a continuous extrusion to ultimately produce the structure 300a. In embodiments, the compostable polymer layer 316b is applied as a patterned or otherwise discontinuous extrusion layer to ultimately produce the structure 300b. The compostable polymer layer 316b forms an extrusion interlayer bonding the first ply 304a to the second ply 308a. The structure 300a or 300b is then wound up on a product wind-up roll 640.

Referring now to FIG. 6C, a manufacturing line 600c for making the second ply portion 308b of the packaging structure 300c is illustrated. The line 600c illustrated is suitable for making the second ply portion 308b of FIGS. 3C and 3D described above. The line 600c includes a substrate roll 632 comprising the second cellulosic substrate 320.

The cellulosic substrate 320 is unrolled from the substrate roll 632 and fed toward an extrusion coater 606 which coats the second major surface of the cellulosic substrate 320 with the first compostable polymer layer 316a. On the way to the coextrusion coater 606, the cellulosic substrate 320 from the substrate roll 632 is fed past a surface treatment station 614a, such as a flame treater, corona treater, plasma treater, or ozone treater that treats the second major surface of the paper substrate 320 such that the compostable polymer layer 316a created at the extrusion coater 606 will adhere well to the treated surface 322 of the substrate 320. In preferred embodiments, the surface treatment station 614a comprises a flame treater.

At the extrusion coater 606, the substrate 320 is fed through a nip point at which point the second compostable polymer layer 316b is applied onto the substrate 320 as a melt curtain. The nip point occurs between a nip roll 618 and a chill roll 628. The compostable polymer material is extruded by a die of the extrusion coater 606 proximate the nip point and is cooled by the chill roll 628 to form the second ply structure 308b. The second ply structure 308b is then wound up on a product wind-up roll 630.

Referring now to FIG. 6D, there is shown a process line 600d for making the film structure 300c or 300d. The line 600d illustrated is suitable for making the film structures 300c and 300d described above. The cellulosic substrate 310 comprising the first ply 304b is unrolled from a substrate roll 602 and fed toward an extrusion lamination station 642 comprising an extruder 606. The cellulosic substrate 310 may have an optional printed ink layer pre-printed or pre-applied to the first major surface of the cellulosic substrate 310.

On the way to the extrusion lamination station 642, the cellulosic substrate 310 from the substrate roll 602 is fed past a surface treatment station 614b, such as a flame treater, corona treater, plasma treater, or ozone treater that treats the second major surface of the paper substrate 310 such that the compostable polymer layer 316a created at the extrusion laminator 606 will adhere well to the treated surface 312 of the substrate 310. In preferred embodiments, the surface treatment station 614b comprises a flame treater.

Meanwhile, the second ply structure 308b is unwound from the roll 630 and fed into the extrusion lamination station 642. The second ply structure 308b and first ply 304b come together and pass through a nip point at which point the second compostable polymer layer 316b is extruded between the first ply structure 304b and the second ply structure 308b as a melt curtain. The nip point occurs between a nip roll 618 and a chill roll 628. The compostable polymer material is extruded by a die of the extrusion coater 606 proximate the nip point and is cooled by the chill roll 628 to form the structure 300c or 300d. In embodiments, the compostable polymer layer 316b is applied as a continuous extrusion to ultimately produce the structure 300c. In embodiments, the compostable polymer layer 316b is applied as a patterned or otherwise discontinuous extrusion layer to ultimately produce the structure 300d. The compostable polymer layer 316b forms an extrusion interlayer bonding the first ply 304b to the second ply 308b. The structure 300c, 300d is then wound up on a product wind-up roll 640.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A compostable laminated packaging film, comprising:
a first cellulosic layer having a first major surface and a second major surface opposite the first major surface, the first major surface of the first cellulosic layer configured to face away from a product to be packaged and wherein the second major surface of the first cellulosic layer has undergone surface treatment;
a second cellulosic layer having a first major surface and a second major surface opposite the first major surface, the first major surface of the second cellulosic layer configured to face toward a product to be packaged and wherein the second major surface of the second cellulosic layer has undergone surface treatment; and
a pattern bonded extrusion interlayer comprising a compostable polymer disposed between the first cellulosic layer and the second cellulosic layer, the pattern bonded extrusion interlayer defining bonded and unbonded regions arranged in a patterned configuration across the compostable laminated packaging film.

2. The compostable laminated packaging film of claim 1, wherein the bonded regions collectively occupy a projected area in the range of from about 5% to about 99% of a total projected area of the compostable laminated packaging film.

3. The compostable laminated packaging film of claim 1, wherein the pattern bonded extrusion interlayer is selectively bonded to the second cellulosic layer to define a pattern of regions that are bonded to the second cellulosic layer and regions that are unbonded to the second cellulosic layer.

4. The compostable laminated packaging film of claim 3, wherein the pattern bonded extrusion interlayer is substantially continuously bonded to the first cellulosic layer and wherein the pattern of regions that are bonded to the second cellulosic layer and regions that are unbonded to the second cellulosic layer defines a plurality of air gaps adjacent to the second cellulosic layer.

5. The compostable laminated packaging film of claim 1, wherein the pattern bonded extrusion interlayer is selectively bonded to the first cellulosic layer to define a pattern of regions that are bonded to the first cellulosic layer and regions that are unbonded to the first cellulosic layer.

6. The compostable laminated packaging film of claim 5, wherein the pattern bonded extrusion interlayer is substantially continuously bonded to the second cellulosic layer and wherein the pattern of regions that are bonded to the first cellulosic layer and regions that are unbonded to the first cellulosic layer defines a plurality of air gaps adjacent to the first cellulosic layer.

7. The compostable laminated packaging film of claim 1, wherein the pattern bonded extrusion interlayer comprises from about 90% to about 100% by weight of one or more compostable and/or biodegradable polymers and from about 0% to about 10% by weight of non-compostable materials.

8. The compostable laminated packaging film of claim 1, wherein:
the first cellulosic layer comprises a material selected from paper and cellophane;
the second cellulosic layer comprises a material selected from paper and cellophane; and
the pattern bonded extrusion interlayer comprises a material selected from the group consisting of a polyhydroxyalkanoate (PHA), polybutylene succinate (PBS), polybutyrate adipate terephthalate (PBAT), polycaprolactone (PCL), and polylactic acid (PLA), or any combination thereof.

9. The compostable laminated packaging film of claim 1, wherein the pattern bonded extrusion interlayer is directly adjacent to the second major surface of the first cellulosic layer and the second major surface of the second cellulosic layer.

10. The compostable laminated packaging film of claim 1, further comprising:
the second major surface of the first cellulosic layer is selected from the group consisting of a flame treated surface, a corona treated surface, a plasma treated surface, an ozone treated surface, and a primer treated surface; and
the second major surface of the second cellulosic layer is selected from the group consisting of a flame treated surface, a corona treated surface, a plasma treated surface, an ozone treated surface, and a primer treated surface.

11. A method for making a compostable laminated packaging film, comprising:
providing a first cellulosic layer having a first major surface and a second major surface opposite the first major surface, the first major surface of the first cellulosic layer configured to face away from a product to be packaged;
modifying the second major surface of the first cellulosic layer with a surface treatment to form a modified surface of the first cellulosic layer;
providing a second cellulosic layer having a first major surface and a second major surface opposite the first major surface, the first major surface of the second cellulosic layer configured to face toward a product to be packaged;
modifying the second major surface of the second cellulosic layer with a surface treatment to form a modified surface of the second cellulosic layer;
extruding a compostable polymer layer intermediate the first and second cellulosic layers; and
forming a pattern bonded interface between the first cellulosic layer and the second cellulosic layer.

12. The method of claim 11, wherein said forming a pattern bonded interface comprises:
feeding the first cellulosic layer and the second cellulosic layer toward a nip between a pair of opposing lamination rollers, wherein the pair of opposing lamination rollers includes a patterned roller having a one or more projections configured to apply a pattern of localized pressure;
extruding a layer of molten compostable polymer material between the first cellulosic layer and the second cellulosic layer immediately upstream of the nip;
passing the first cellulosic layer, the second cellulosic layer, and the layer of molten compostable polymer material through the nip, wherein the pattern of localized pressure causes the molten polymer, upon cooling, to form the patterned bond interface between the first cellulosic layer and the second cellulosic layer.

13. The method of claim 12, wherein the patterned bond interface comprises bonded and unbonded regions between the second major surface of the first cellulosic layer and the pattern bonded extrusion interlayer, wherein the bonded and unbonded regions are arranged in a patterned configuration across the compostable laminated packaging film.

14. The method of claim 12, wherein the patterned bond interface comprises bonded and unbonded regions between the second major surface of the second cellulosic layer and the pattern bonded extrusion interlayer, wherein the bonded and unbonded regions are arranged in a patterned configuration across the compostable laminated packaging film.

15. The method of claim 11, wherein:
the first cellulosic layer comprises a material selected from paper and cellophane;
the second cellulosic layer comprises a material selected from paper and cellophane; and
the compostable polymer layer comprises a material selected from the group consisting of a polyhydroxyalkanoate (PHA), polybutylene succinate (PBS), polybutyrate adipate terephthalate (PBAT), or polylactic acid (PLA), polycaprolactone (PCL), or any combination thereof.

16. The method of claim 11, wherein the bonded regions collectively occupy a projected area in the range of from about 5% to about 99% of a total projected area of the laminate.

17. The method of claim 11, wherein the compostable polymer layer is extruded to be directly adjacent to the second major surface of the first cellulosic layer and the second major surface of the second cellulosic layer.

18. The method of claim 11, wherein modifying the second major surface of the first cellulosic layer and modifying the second major surface of the second cellulosic layer each comprise a treatment independently selected from the group consisting of flame treatment, corona treatment, plasma treatment, ozone treatment, and primer treatment.

19. A method for making a compostable laminated packaging film, comprising:
feeding a first cellulosic layer and a second cellulosic layer toward a nip between a patterned nip roll and a chill roll, the patterned nip roll having one or more projections configured to apply a pattern of localized pressure;
extruding a layer of molten compostable polymer between the first and second cellulosic layers to form an extrusion interlayer; and
passing the first cellulosic layer, the layer of molten compostable polymer, and the second first cellulosic layer through the nip, wherein the pattern of localized pressure causes the molten compostable polymer, upon cooling, to form a patterned bond interface between the first cellulosic layer and the second cellulosic layer, wherein the patterned bond interface comprises bonded and unbonded regions arranged in a patterned configuration and disposed at one or both of:
an interface between the first cellulosic layer and the extrusion interlayer; and
an interface between the second cellulosic layer and the extrusion interlayer.

20. A packaging article comprising the compostable laminated packaging film of claim 1.
